(19) United States
(12) Patent Application Publication
(10) Pub. No.: US 2008/0312962 A1
(43) Pub. Date: Dec. 18, 2008

(54) SYSTEM AND METHOD FOR PROVIDING SERVICES VIA A NETWORK IN AN EMERGENCY CONTEXT

(75) Inventor: Michael Kirkwood, Berkeley, CA (US)

Correspondence Address: KNOBBE MARTENS OLSON & BEAR LLP, 2040 MAIN STREET, FOURTEENTH FLOOR, IRVINE, CA, 92614, US

(73) Assignee: Polka Network, Inc., Berkeley, CA (US)

(21) Appl. No.: 12/119,398

(22) Filed: May 12, 2008

Related U.S. Application Data
(63) Continuation-in-part of application No. 11/868,826, filed on Oct. 8, 2007.
Application No. 11/868,826 is a continuation-in-part of application No. 11/868,937, filed on Oct. 8, 2007.
(60) Provisional application No. 60/917,618, filed on May 11, 2007.
(60) Provisional application No. 60/917,618, filed on May 11, 2007.
(60) Provisional application No. 60/917,618, filed on May 11, 2007.

(51) Int. Cl. G06Q 50/00

(52) U.S. Cl. 705/2

(57) ABSTRACT

A computer-implemented method of providing services using a digital network in an emergency context is provided. In some embodiments, information about a person may be delivered across a network to assist in an emergency medical situation related to that person. The information may be obtained by receiving into the network data indicative of an emergency contact for a person, medical information related to the person, and an emergency personal page pass phrase. Based on the data, an emergency medical card is generated and delivered to the user. The user carries the card on their possession and it may be used in case of an emergency.

### CROSS-REFERENCE TO RELATED APPLICATIONS

This application is a continuation in part of U.S. patent application Ser. No. 11/868,826, filed Oct. 8, 2007, which claims the benefit of co-pending U.S. Provisional Application No. 60/917,618 filed on May 11, 2007. This application is also a continuation in part of U.S. patent application Ser. No. 11/868,937, filed on Oct. 8, 2007, which claims the benefit of U.S. Provisional Application No. 60/917,618, filed on May 11, 2007. This application also claims the benefit of U.S. Provisional Patent Application No. 60/917,618, filed on May 11, 2007. The disclosure of each of the above-referenced patent applications is incorporated by reference herein it is entirety.

### BACKGROUND OF THE INVENTION

1. Field of the Invention

This application relates to the management of entities, identities, and contexts in a network, such as a computer network, voice network, or some other link between objects through a defined protocol. More particularly, this application relates to a system and method for modeling and abstracting information representing real world objects and ideas to enable more persistent, secure, and easy to use applications for people and businesses.

2. Description of the Related Art

In recent years, society has become more and more reliant upon the electronic exchange of information in order to provide insight into real world scenarios and conditions. Businesses in particular, rely on the capture, storage, and analysis of data and information to improve efficiency and accuracy in their business models. As an increasing number of businesses have begun storing important information, a need arose for companies to share information and data with each other in order to improve how they conduct business with each other.

For example, when two companies conducted a business transaction, each of their respective data systems needed to be updated to reflect that transaction. However, there was a problem in that companies tended to use non-standardized systems which prevented them from easily sharing information. To address this problem, standards for structuring information to be electronically exchanged were proposed. One of the better known standards developed to address these needs is Electronic Data Interchange (EDI) which is a set of specifications which allows trading partners to exchange information with little regard to the type of software or system installed on the other side of the transaction.

EDI and other technologies have improved the sharing of electronic information. However, there remains a considerable amount of information and data which is not captured through the existing EDI technologies. For example, although business transactions may be captured in significant detail, the computer systems which support these transactions do not enable effective data information flow across the entire supply chain, especially between dimensions such as time or connection points that connect to the consumer such as retail channel or post-retail transactions. Although the computer systems of manufacturers are typically configured to effectively share information with their distributors, as products proceed further along the supply chain to retailers and ultimately to consumers, the corresponding transaction data is not effectively communicated back up the chain. One consequence of this disconnect is that information about consumers is not effectively distributed to others in the supply chain, or across providers of additional services such as medial providers in a health network.

Take, for example, the case of when a person moves to a new home. Many companies in the supply chain may store information about the person. However, when the person moves to the new home, this information is not made available to the companies unless the person takes affirmative steps to update their information with each company. Moreover, even if the person takes steps to update their information with one company in the supply chain, the companies do not effectively share this information with other companies with whom they conduct business. In sum, there is no identity synchronization between many disparate computer systems and networks within the supply chain. Although some attempts have been made to provide this type of service, such as Microsoft Passport, these services are generally limited to the consumer/retailer side of the product lifecycle portion of the supply chain, and do not adequately address the needs of manufacturers and distributors, nor the needs of the individual, who is an critical source of the information about themselves, what they do with the products they buy, and how they interact with other things in their world. Accordingly, what is needed is a system which solves these and other shortcomings.

### SUMMARY OF CERTAIN INVENTIVE ASPECTS

The system, method, and devices of the present invention each have several aspects, no single one of which is solely responsible for its desirable attributes. Without limiting the scope of this invention, several of its features will now be discussed briefly.

In a first embodiment, a computer-implemented method of delivering information across a network to assist in an emergency medical situation is provided. The method includes receiving data indicative of an emergency contact for a person and medical information related to the person. The method further includes generating an emergency medical card based on the received data and delivering the generated emergency medical card to the subscriber.

In a second embodiment, a computer-implemented method of delivering a message to an emergency medical contact over a network during a medical emergency related to a person is provided. The method comprises receiving a request to display a personal emergency page related to the person. The request comprises data indicative of a pass phrase. The method further includes granting access to the personal emergency page if the pass phrase is sufficient. A request is received to send a message to the emergency medical contact. The location of a most recent communication with the emergency medical contact via the network is determined, and a message is transmitted to the emergency medical contact at the determined location.

In a third embodiment, a system for providing an identity-specific service in a network is provided. The system includes a first module configured to receive and store information related to an identity in the network. A second module is configured to provide a user interface which allows a person associated with the identity to specify authorized connections for the stored information based on the context of the connections, and a third module is configured to receive requests to from network objects to connect to the stored information, and permit or deny access based on the specified authorized connections and the context of the requests.

In a fourth embodiment, a mobile device configured to provide an emergency medical card service in a network is provided. The mobile device comprises a first module configured to receive and store information related to an identity in the network; a second module configured to provide a user interface which allows a person associated with the identity to specify authorized connections for the stored information based on the context of the connections; and a third module configured to receive requests to from network objects to connect to the stored information, and permit or deny access based on the specified authorized connections and the context of the requests.

In a fifth embodiment, a mobile device is configured to provide an emergency medical card service in a network. The mobile device comprises a first module configured to display a selection element which activates an emergency medical card application stored on the mobile device; a second module configured to determine whether the user activating the emergency medical card application is the owner of the mobile device; and a third module configured to selectively display information related to the emergency medical card based on the determination of the second module.

### BRIEF DESCRIPTION OF THE DRAWINGS

In this description, reference is made to the drawings wherein like parts are designated with like numerals throughout.

FIG. 1 is a block diagram that provides a top-level overview of how a person connects to a network in accordance with various embodiments.

FIG. 2 is a block diagram of an entity data object of the network from FIG. 1.

FIG. 3 is a block diagram of an identity data object of the network from FIG. 1.

FIG. 4 is a block diagram showing examples of context in which entities and identities may exist.

FIG. 5 is a block diagram illustrating how an identity may be represented within the network based on the contexts from FIG. 4.

FIG. 6 is an example of how two real world persons may share information based on the context.

FIG. 7 is a block diagram providing an example of the use of context to manufacturer coupon information across a supply chain.

FIG. 8 is a flowchart of a process by which the network of FIG. 1 sets a context for a device connecting to the network.

FIG. 9 is a flowchart of a process for sending a coupon to a mobile device of a user based on a defined context.

FIG. 10 is a flowchart of how the network may handle a transaction from FIG. 9.

FIG. 11 is a flowchart of how the network may handle a user's change of address request.

FIGS. 12A and 12B are block diagrams providing examples data of a healthcare context and the use of the network to provide assistance in a medical emergency.

FIG. 13 is an example of a medical emergency card from FIG. 12.

FIG. 14 is an example of an emergency web page that may be associated with the medical emergency card from FIG. 13.

FIG. 15 is a flowchart describing a process for generating the emergency card from FIG. 13 and the web page from FIG. 14.

FIG. 16 is a flowchart of a process by which translation services may be provided for emergency card and web page.

FIG. 17 is a flowchart describing how the emergency medical card may be used in a medical emergency context.

FIG. 18 is a flowchart showing how the emergency medical contact may be located.

FIG. 19A is a more detailed description of the process from FIG. 18.

FIG. 19B provides an illustration of an advocate verification process.

FIG. 20A is a mobile device providing an emergency medical card.

FIG. 20B is an example of a mobile device de-identifying data based on the user and the context.

FIG. 21 is an example of a mobile device configured to manage multiple emergency cards.

### DETAILED DESCRIPTION

Various embodiments include systems and methods which provide persons and businesses with the ability to share information across the supply chain in a way that allows real world entities to be abstracted as data objects, and allows access to the data objects based on their ever-changing context in the world around them. By connecting data objects and sharing information among them based on their context, network entities are given more precise control over how information is shared and with whom it is shared.

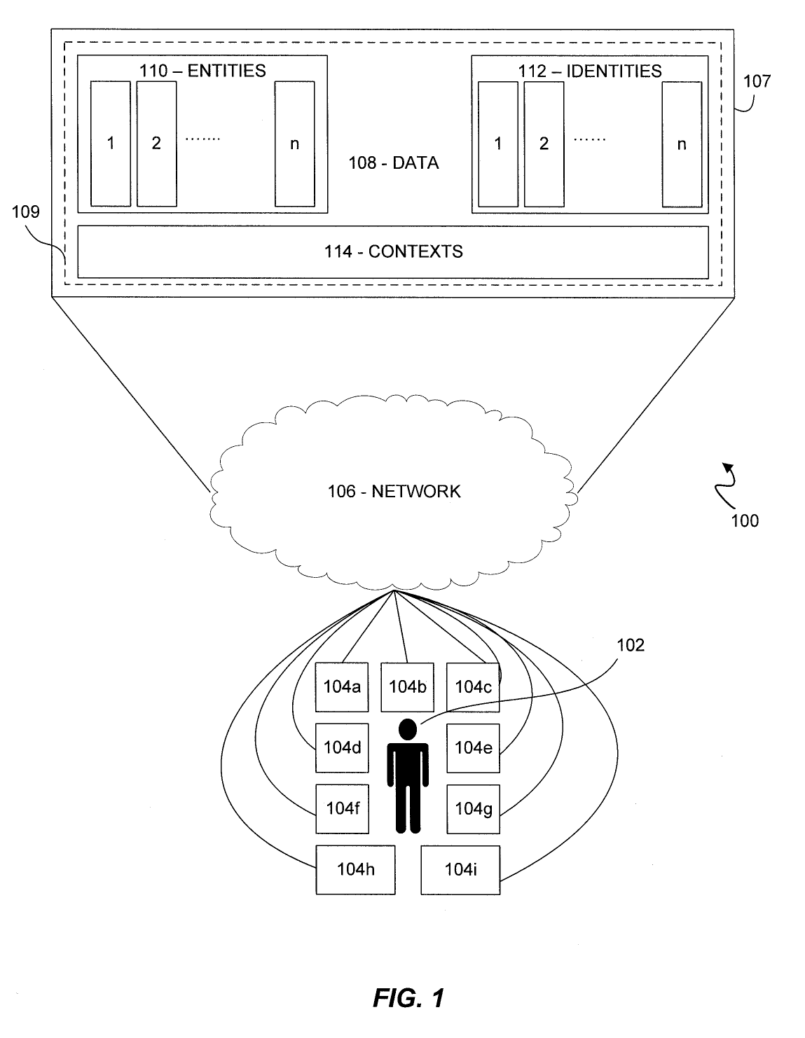

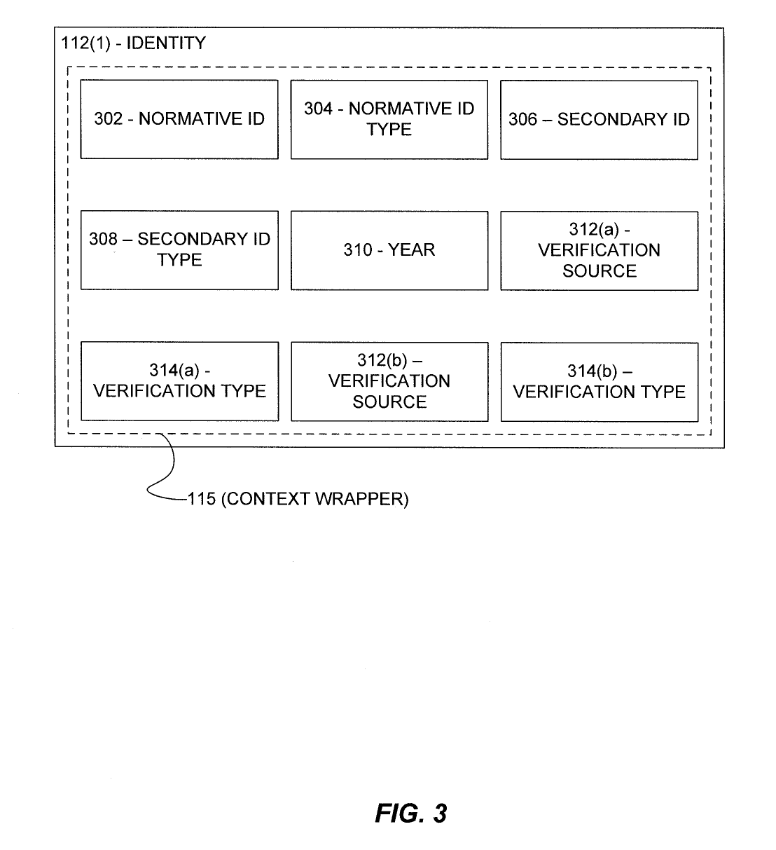

Certain embodiments are implemented within a network environment. FIG. 1 provides a top-level view of a network environment 100 suitable for implementing various embodiments described herein. The network environment 100 includes a network 106. The network 106 is a computer network which may be connected to, or include, various other computer networks such as the Internet, wireless networks such as 3G or WiMAX networks, telephone networks, EDI networks, websites, services, print documents, access devices, bar codes, human enabled processes, and other types of networks. Connected to the network 106 is a server 107 which includes data 108. At least some of the data 108 is stored as data objects 109 within the server 107. Some of the data objects 109 represent a data abstraction of some real world thing or idea and are termed “identity objects”. The identity objects 112 may represent individual people or individual products. It should be realized that such a data abstraction of a real world person or product is unique to that person or product. Thus, in one embodiment, the identity object for a particular person is unique to that person. There are no other identity objects which represent that particular person. Similarly, a data abstraction of a particular television set is unique to an individual set. There would be one identity object for each separate television set, even if the televisions are identical. For example, each identity object may correspond to a serial number and model number of a particular television set. The identity object 112 is a data object which abstracts an identity, and will be discussed in further detail in connection with FIG. 3.

Other types of objects 109 stored in the server 107 include entity objects 110. As used herein, an entity object is a data object that, in one embodiment, represents an idea of a thing, person, place or product. An entity object 110 is a data object which abstracts a representation of an idea. For example, there may be an entity object which corresponds to 42″ LCD televisions. This object is not specific for an individual television set, but rather represents the concept of a 42″ LCD television. Similarly, there may be entity objects that represent a FORD TAURUS® automobile. The object is not particular to a specific car, but rather represents the type of that car (which may be represented in many different ways in the networks, including different naming convention, within different network protocols).

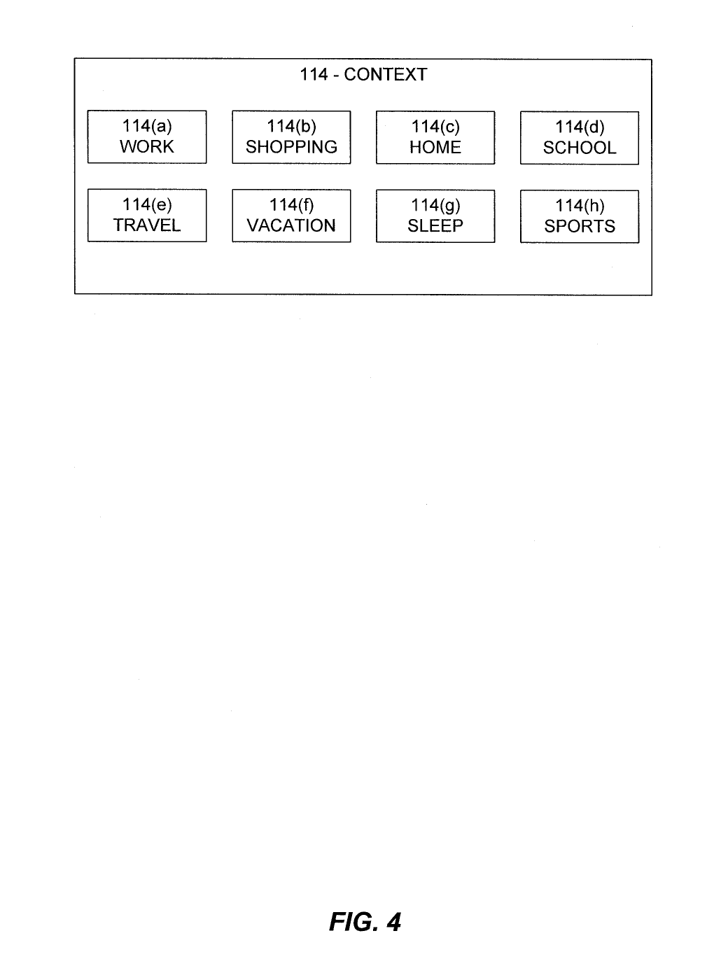

The data objects 109 in the network 106 may further include context data 114. In some embodiments, context refers to the facts or circumstances within which a data object 109 is perceived. In other embodiments, context may include only circumstances within which a data object 109 is perceived, with facts related to a data object stored separately. Context data 114 generally includes data that how other data objects 109 are viewed and referred to within the network 106. For example, a context may be “shopping”, “driving”, or “at work”. Such contexts can be selected by users of the system to indicate how they are currently utilizing data objects. Facts regarding a data object, such as a person named Mike, may include “Mike is a male born in 1977”, “Mike was born at Scripps Memorial Hospital”, “Mike has two children”, or “Mike drives a Toyota”. Circumstances regarding Mike may include “Mike is at work”, “Mike is on vacation”, “Mike is shopping for a new car”, or “Mike is sleeping”, “Mike is in an emergency”. Facts regarding a data object, such as a television set, may include “The TV has a 42-inch LCD screen”, “The TV is a flat-screen television”, or “The TV was manufactured by Toshiba”. Circumstances regarding the television set may include “The TV is on”, “The TV is set to channel 13”, or “The TV is broken”. Thus, in some embodiments, circumstances occur over a shorten time span than facts. Circumstances may last an hour, a few hours, a day, a few days, a month, a few months, a year, etc. Facts may be unchanging or occur over longer time spans. A data object may be associated with facts or circumstances that are not currently true, but may be true at times. For instance, the data object corresponding to a person named Mike may include the context “Mike is at work” when Mike is not at work, however the context would not be applied in that case, i.e. the context would not be selected. As, in some cases, the distinction between facts and circumstances can be somewhat arbitrary, in some embodiments of the system, context is broken into a plurality of categories, each category containing a plurality of contexts specific to an estimated time-interval over which it may occur. For instance, “Mike is a male born in 1977” may be put into a permanent category, “Mike drives a BMW” may be put into a semi-permanent category, and “Mike is at work” might be put into a transient category. The number of categories may vary. Context data will be described in further detail below in connection with FIG. 4.

As shown in FIG. 1, the network 106 may store many entity objects 110(1). . . 110(m). Similarly, the network 106 may also store many identity objects 112(1). . . 112(n). In addition, contexts 114 may be defined on a per object basis which means that each entity object 110 and each identity object 112 may have one or more contexts 114 associated with it.

Connecting to the network 106 may be a person 102 (also referred to herein as a user). The person 102 may connect to the network utilizing one of various network-enabled devices 104a . . . 104i. The network-enabled devices may include various types of hardware devices such as computers, handheld devices, televisions, mobile phones, GPS devices, Bluetooth enabled devices, RFID tags/devices, UPC tags/devices, or some other network-enabled devices somehow associated with a user 102. The various devices 104 may connect directly to the network 106 via a wireless or wired connection. Alternatively, the devices 104 may connect to other networks which are connected to the network 106. The user 102 may send and receive data from the network 106 using the devices 104 in a manner described in more detail below.

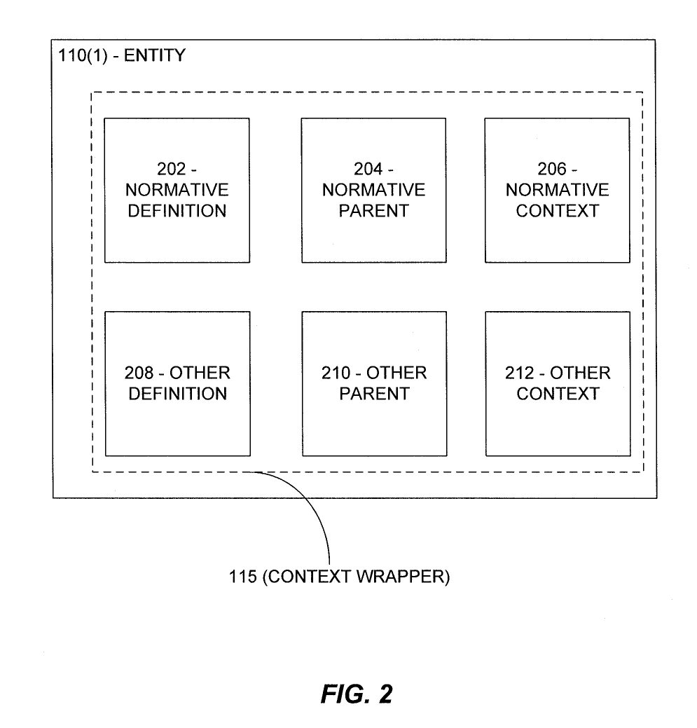

Referring now to FIG. 2, a more detailed view of an entity object 110(1) is provided. As noted above, an entity object 110(1) may have one or more associated contexts 114. To illustrate this association, the entity object 110(1) is shown with a context wrapper 115. Within each context wrapper 115, the entity object includes data which describes the entity within the specified context. An entity, such as entity 110(1), for example, may include normative definition data 202 which defines the concept being abstracted by the entity within the context 114 specified by the context wrapper 115. The normative definition data 202 includes data which defines the entity that is represented by the entity object 110(1). Each entity 110 may also include a normative parent data 204. The normative parent data 204 is data which represents a parent object of the entity object 110(1) within the context 114 defined by the context wrapper 115. The parent object may be an entity object 110 or an identity object 112. Within each context wrapper 115 associated with the entity object 110(1) may also be the normative context 206. The normative context 206 is the description of the context 114 that is specified by the context wrapper 115. In addition to the normative data provided within each context wrapper 115, each entity object 110(1) may further include an alternate definition 208, an alternate parent 210 and an alternate context 212. Providing alternate data such as the alternate definition 208, the alternate parent 210, and the alternate context 212 allows the user to be viewed simultaneously with different names, handles, or other identifiers in different systems that are being used, while maintaining a normalized key, protocol or service within the network 106 that enables the user to participate in transactions within the network, while utilizing the best features of each local network. By way of example and not of limitation, an entity object 110(1) may have a normative definition 204 which includes a specific name “Michael Smith” when using a credit card, in a credit card context. However, the network 106 may select an alternate definition 208, such as “Mike Smith” that is used many other places. In another context, the entity object may have still another alternate definition 208, such as “eek”, which corresponds to Mike's handle when using an online video game.

Referring now to FIG. 3, a more detailed view of identity object 112(1) is provided. As with the entity object 110(1), an identity object may have one or more contexts 114 associated therewith. As shown in FIG. 3, one particular context 114 is shown within a context wrapper 115. However, an identity 112(1) may have many different contexts each of which are delineated by a context wrapper 115. The identity object 112(1) may include a normative identification value or pattern. The normative identification value 302 is typically a unique identifier which distinguishes the real world thing which is represented by the identity. The identity 112(1) may also include a normative identifier type 304. The normative identifier type is the data type for the normative identity value 302. A normative identifier type 304 enables the network 106 to create a series of identifiers so as to maintain different sets of context for each object. For example, normative identifier types may include “long encrypted”, “16 character”, “picture”, “watermark”, “sensor”, or “logon”, “document id”, “service id”. Having different normative identifier types allows the network to provide proof of identity in various forms such that it is not constrained to one representation. This capability is particularly useful in situations where more and more devices are interconnected using various pervasive, near-field, sensor systems because it allows users to users to define contact with the devices around them by specifying rules of engagement between the various devices.

Normative identifier types 304 may also be combined for specific contexts in which the user exists. For example a normative identifier type 304 can be defined for a context in which the user is shopping with their mobile phone. Ordinarily, there may be an identifier associated with the user “MikeSmithMobileShop.” Which could be ID+ID+ID+ID (an id for each concept). This could be further extended to MikeSmithMobileBuy, which may look like IDLongVersion+IDLongVersion+ID+Logon. Accordingly, the identifier of the object can join with other identifiers and contexts to become more specific. Once the combination of normative identifiers has been created and processed, it can be made reusable by the system, or further obfuscated in encryption or some other security layer.

Each identity 112(1) may further include a secondary identifier 306 and a secondary identifier type 308 which may be alternative way of uniquely identifying the real world object represented by the identity object 112(1).

Depending on the type of object represented, the identity may include various other data fields which store relevant data about the identity object. As was briefly noted above, an identity object within the network 106 is a data abstraction of an object verified to exist in the real world. As such, each identity object 112 will store data related to how and when its existence has been verified. For example, identity objects 112 may include time data 310 which indicates the most recent date at which the existence of the object has been verified. The identity object 112(1) may further include one or more verification sources 312 which represent the entities 110 or identities 112 which have been used to verify this objects real world existence. Verification sources 312 may include logon records, session logs, cookies, sensors, magnetic strips, network identity services, operating system identity services, applications, cameras, retinal scanners, passwords, algorithms, directories, lists, databases, or frameworks. The verification source 312 can be different on different networks, applications, and contexts depending on the actions that are being performed. The identity objects may further include verification types 314 which provide information about the nature of the verification source 312. The verification types provide additional ways to abstract the verification sources 312. This enables the network 106 to define dependent actions based on verification types 314, rather than only being able to access the sources themselves. For example, an identity object 112 may be designated as having a verification type of “requiring network services.” Depending on the context in which the identity object 112 is operating, the network 106 can quickly determine if it can perform that type of verification. Other types of verification may be based on security level, application functionality, standards, technologies, or other standard questions such as who, what, where, why, how it runs.

Because identity objects represent a real world objects that have been verified to exist (in a given context), and thus may be granted certain privileges in the network based on these verifications, the verification data 312 and 314 provides a basis for which other objects in the network 106 may grant privileges.

Referring now to FIG. 4, a more detailed view of context data 114 from FIG. 1 is provided. As noted previously, context 114 refers to a set of facts or circumstances that within which a data object 109 is perceived. Contexts 114 stored in the network 106 may include general contexts and object-specified contexts. FIG. 4 illustrates various examples of general contexts 114. These general contexts may include a work context 114(a) which means that the data object 109 operating within the context is in a work environment. The general contexts may also include a shopping context 114(b) which means that the data object 109 operating within the context is in a shopping environment. Various other general contexts may include a home context 114(c), a school context 114(d), a travel context 114(e), a vacation context 114(f), a sleep context 114(g), and a sports context 114(h). Contexts 114 may also be defined that are specific to a particular data object. For example, a data object 109 may represent a specific person. That person may wish to define a context specific to a real world environment situation such as being in a specific location (such as a foreign country, for example), or being with a specific person (such as a business associate) or group of persons (such as their family). Each of these specified contexts 114 for a data object allows access to the data object to be managed according to its current context(s) and the rules defined and associated therewith. Contexts maybe grouped, nested, layered, and connected to other contexts 114. For example, if “Mike” has “Private” context (which generally makes “Mike” unavailable to others through the network 106), and “Megan” (married to Mike) has an emergency context, the emergency context of “Megan” may override the general rules of the “Private” context of “Mike.” Thus, if “Megan” is set to emergency, the network 106 may send a message to “Megan” indicating the location and status of “Mike”, e.g. Mike is in car, with phone. Extending further, if “Megan” has an emergency, and “Mike” isn't reachable, but Ben is Mike's best friend, and was last seen with Mike, the private context of “Mike” may enable the network 106 to send a message to “Mike” on behalf of “Megan” (without providing additional information without the consent of “Mike”).

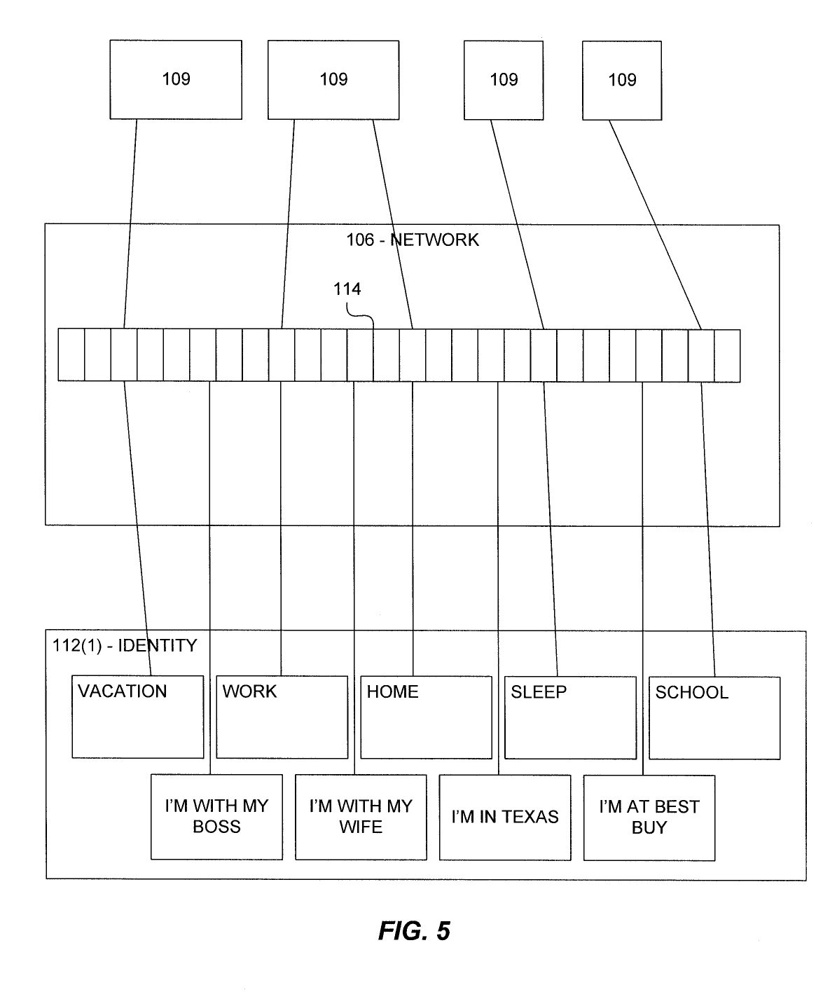

To further illustrate, an example of how a specific identity object 112(1) may communicate with other data objects 109 within the network 106 is provided in FIG. 5. In this particular example, the identity object 112(1) represents a person who connects to the network 106 in various ways depending on the situation they are in. The identity object 112(1) includes several situations which become defined contexts 114 for the identity object 112(1). Some of the situations align with general contexts 114 which are not specific to the identity object 112. These include “VACATION”, “WORK”, “HOME”, “SLEEP”, and “SCHOOL”. There may be many other general contexts available to the object. Other contexts 114 are defined that are specific to the identity object 112. These specific contexts 114 may be defined by the person associated with this identity object, or they may be defined by the network 106 based on the object's previous interactions with the network 106. These structures and relationships may be complex in nature and ever-changing, however, as shown in FIG. 5 they may include object-specific contexts 114 such as “I'M WITH MY BOSS” and “I'M AT BEST BUY”, “I−M IN AN EMERGENCY”. Depending on the context, the identity object 112(1) is made available to other data objects 109 in the network. Thus, while in the “WORK” context, the identity object 112(1) may be available to one group of data objects in the network, while in the “SLEEP” context, the identity object 112(1) may be available to other data objects.

In some embodiments, the user is able to define how its identity object will communicate with the network 106 based depending on the context. Thus, for the contexts shown in FIG. 5, the user may specify who has access to communicate with them, and they may further define the terms of those communications. For example, the user associated with the identity object 112(1) may define the “I'M WITH MY BOSS” context such that only emergency communications from certain other specified data objects (such as an identity object 112(2) representative of a family member of the user) can reach him when that context has been set within the network 106.

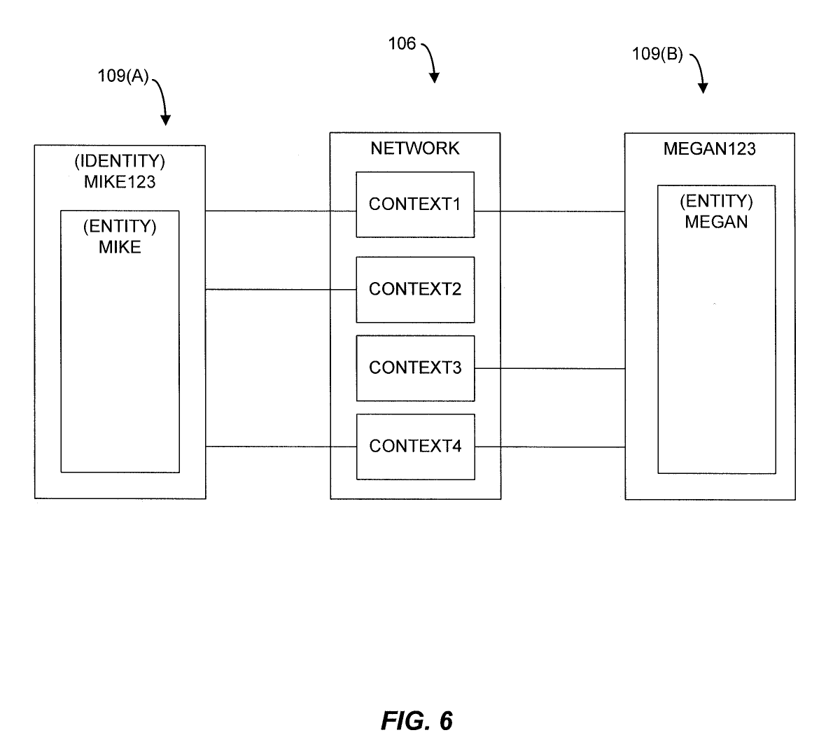

The contexts 114 defined for objects may also govern how two objects communicate through the network 106. FIG. 6 provides an illustration of how communication between two data objects 109(a) and 109(b) in the network 106 varies depending on the current context of the data objects. Data object 109(a) is an identity object with a normative identifier 302 of “MIKE123”. This identity object is associated with the entity object “MIKE” which represents the concept of the person “Mike” in the real world. Similarly, the data object 109(b) comprises an identity object with a normative identifier 302 of “MEGAN123”. This identity object is associated with the entity object “MEGAN” which represents the concept of the person “Megan” in the real world.

Within the network 106 are various contexts 114. Relationships may be provided using various contexts. As used herein, a relationship describes if two objects communicate, and if so, how two objects communicate. The relationship may further define the information that can be communicated. The relationship may further define how or in what form an object receives the information. In certain ones of the contexts (CONTEXT1 and CONTEXT4, for example), the “MIKE” data object 109(a) communicates with the “MEGAN” data object 109(a) via the network 106. In other contexts, however, the two data objects do not communicate. There can be various reasons why the objects do not communicate in certain contexts. For example, the “MIKE” data object 109(a) may have set its context to “PRIVATE” so that he is not visible to any other network objects. In such a situation (as is shown with CONTEXT2 in the drawing), the “MIKE” data object 109(a) will still connect with the network 106, but the “MEGAN” object is not able to communicate with “MIKE” while in that context. Similarly, there may be contexts (such as CONTEXT3, for example) where “MIKE” 109(a) cannot communicate with “MEGAN” 109(b) through the network based on a context set by Megan. Thus, the use of context 114 allows network objects 109 to control how they interact with the network 106, and further control how the network is able to interact with them.

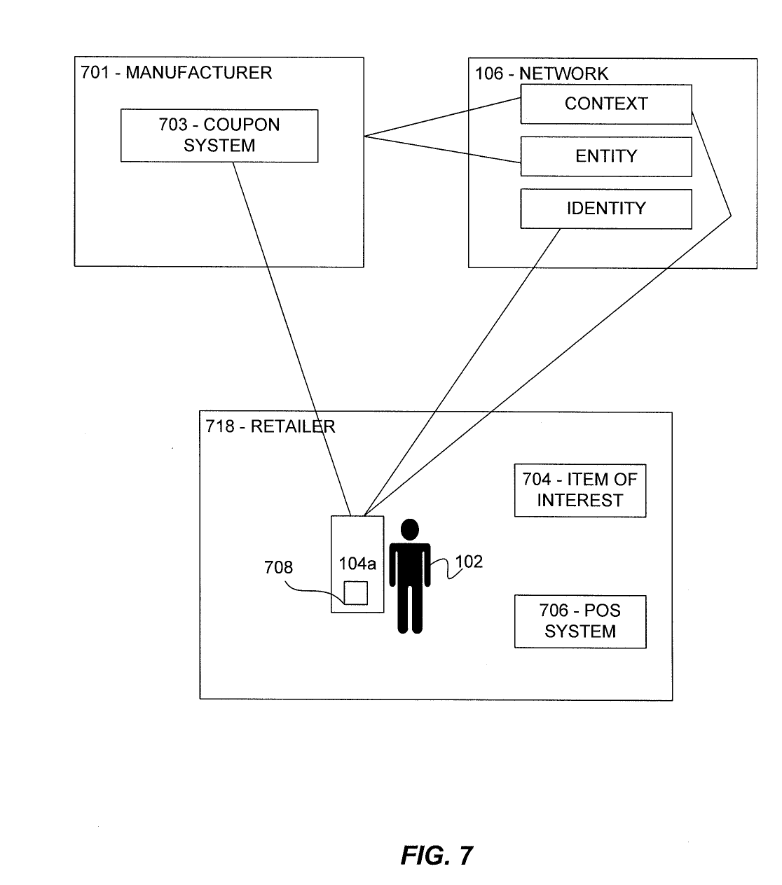

In one particular embodiment the network 106 allows a context 114 to be defined for a person as they shop for products. Based on this context 114 various entities and identities within the supply chain may be allowed to communicate with the person based on rules defined by that person for the specific context. FIG. 7 is a block diagram illustrating a use case in which a user may receive a mobile coupon through the network 106 based on a specified context 114. As shown in the diagram a person 102 is located at a retailer premises 718. The person 102 has a network enabled device 104(a) such as a mobile phone which connects to the network 106. The mobile phone device 104(a) has an associated identity object 112 in the network 106. When the person 102 enters the retailer 718, he may set the current context within the network 106 to “SHOPPING”. Alternatively, the network 106 may be configured to automatically detect his presence in that location and set the context 114 for the device 104a automatically.

Within the retailer premises 718 may be one or more items of interest 704 which the person 102 wishes to possibly purchase. These items may be specified by the person 102 within the context 114, or they may be determined by the network 106 based on previous business transactions may be the person 102 within the network 106. Also located at the retailer premises is a point of sale (POS) system 706. The POS system 706 may be connected to the network 106, or it may be connected to some other computing device with connects directly to the network 106.

Also connected to the network 106 may be a manufacturer 701. The manufacturer 701 may be a network object 109 such as an entity 110 or an identity 112. The manufacturer 701 may include a coupon system 703 which is configured to send coupons to mobile devices such as 104(a) for the purchase of items provided by the manufacturer through the retailer 718. The coupon system 703 may be configured to provide general coupons for all of the manufacturer products, or it may be configured to provide coupons for specific products sold at the retailer 718.

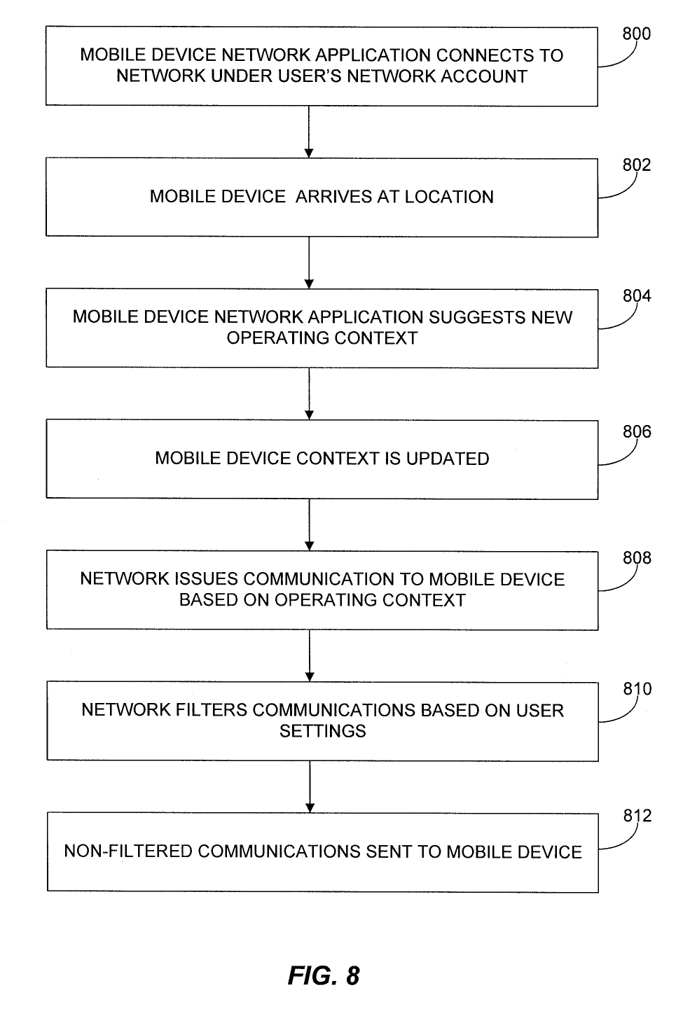

As noted above, context 114 for a network object 109 such as the mobile phone 104(a) may be set based on a user's location. FIG. 8 is a flowchart of a process by which a mobile device of a user (such as mobile device 104(a) from FIG. 7) can attach to the network 106 and communicate with other objects on the network based on the context 114. The process begins at block 800 where the mobile device connects to the network using a network account associated with the person 102 using the mobile device 104(a). Upon connecting to the network 106, the mobile device 104(a) is recognized as a data object 109 (either an entity 110 or an identity 112) in the network 106 and an initial context is set for the data object 109. Next, the mobile device 104(a) arrives at a location such as retailer 718, for example at block 802. Upon arriving at the new location, the network 106 suggests a new operating context for the mobile device at block 804. As discussed above, this process may be automatic, or in some embodiments, the user 102 may specify the context 114 manually. Next at block 806, the context 114 for the mobile device 104(a) is update within the network 106. Once the context 114 has been updated, the network 106 then routes messages to the mobile device 104(a) at block 808. At block 810, the network filters the messages based on the settings associated with the context 114. To further illustrate this filtering, if “Megan” calls “Mike” with an emergency, and she is in group “Family”, it may overrides a standard privacy setting for “Mike.” “Mike” has ultimate control, but can have selective filtering rules which extend to email, voice, voice over IP (VOIP), sms, video, rss, print and other communication methods that “Megan” (or some other family member identity object) may use to contact “Mike”. Once the messages are filtered, the non-filtered messages are sent to the mobile device at block 812.

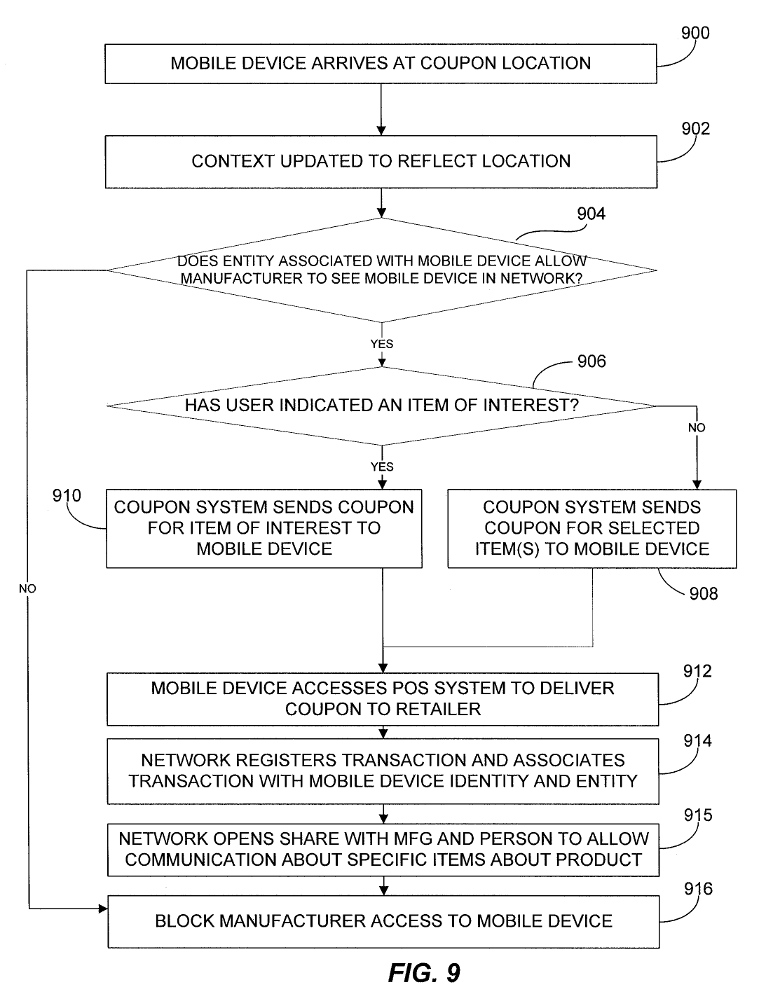

As noted above in connection with FIG. 7, certain embodiments provide manufactures with the ability to send mobile coupons to mobile devices 104(a) based on their current context 114. FIG. 9 is a flowchart describing an example of such as process. The process begins at block 900 where a mobile device 104(a) associated with a person 102 arrives at a coupon location such as the retailer 718. Next, the context of the mobile device 104(a) is updated to reflect the location. This update may be accomplished using the process described above in connection with FIG. 8. Next, the process moves to decision block 904 where the network determines whether the person 102 associated with the mobile device 104(a) has set the context to allow the manufacturer 701 to see the mobile device within the network 106. If the person 102 has not allowed the manufacturer 701 to be made aware of his presence at the retailing location, the process skips to block 916 where the network 106 block manufacturer access to the mobile device.

If at decision step 904, the person associated with the mobile device identity object does in fact allow the manufacturer 701 to see the mobile device in the current context 114, the process moves to another decision block 906. At decision block 906 the system checks to see if the user 102 has indicated an item of interest. For example, this indication may be from an input into the device. Alternatively, the device may detect the presence of the item of interest via RFID or some other signal emitted by a device. If the user indicates an item of interest, the process moves to block 910 where the manufacturer receives notification of the item of interest and in response the coupon system 703 of the manufacturer 701 sends a coupon to the mobile device 104(a). If the user does not indicate an item of interest at decision block 906, the process instead moves to block 908 where the coupon system 703 sends coupons for selected item(s) which are available at the retailer location 718 to the mobile device coupon system.

From either block 908 or 910, the process moves then to block 912 where the mobile device 104(a) accesses the point of sale system 706 to deliver the coupon to the retailer. Typically this will occur when the user 102 has made a purchasing decision and arrives at the point of sale. Once the coupon has been delivered to the POS system 706, at block 914 the network registers the transaction and associates the transaction the mobile device identity and the other parties involved in the transaction. After the transaction has been registered in the network, the process then moves to block 915 where the network provides an interface to allow the customer to define how they would like future communication from the manufacturer regarding the purchased product.

As noted above, in block 914, the network 106 registers the transaction and associates the transaction with the parties involved. Storing information about the transaction allows details about the transaction to be shared throughout the supply chain and to be extended retail channels and post-sale experiences. In some embodiments, the system allows the purchaser 102 and manufacturer 701 to develop a framework for future network communications regarding the purchase. For example, the user may specify a set of contexts 114 in which it would be appropriate for the manufacturer to communicate with the user 102 via the network 106.

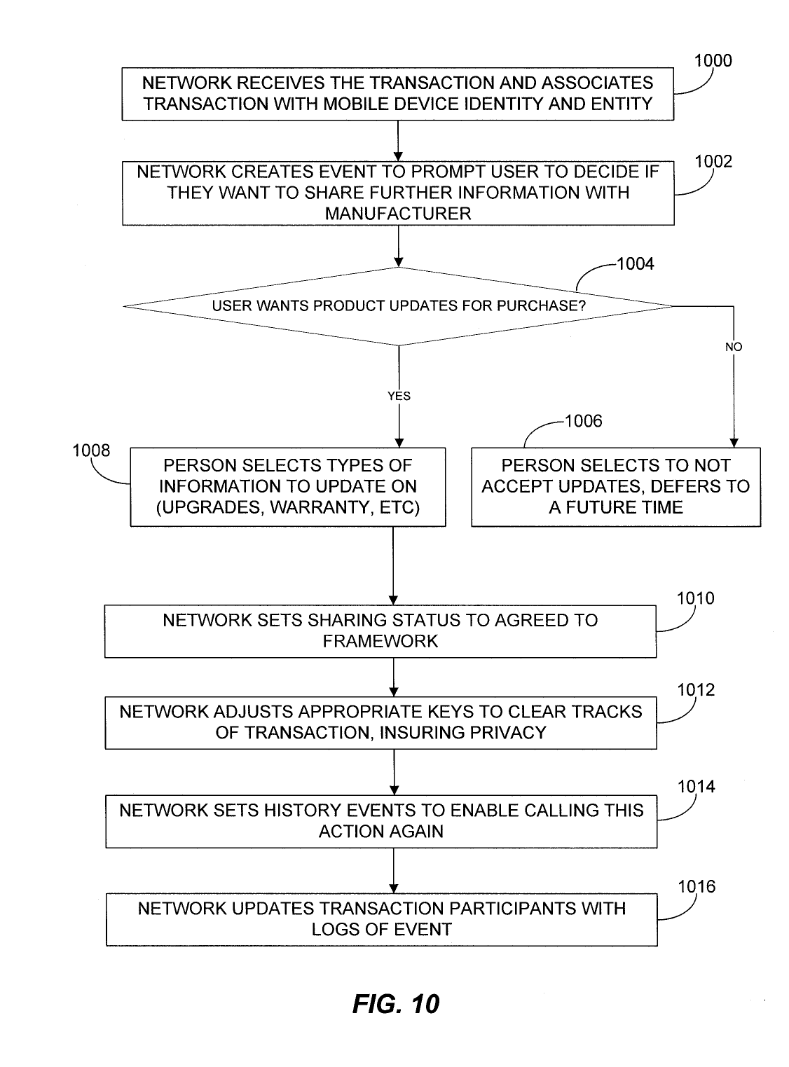

Referring now to FIG. 10, a more detailed view of how the network may handle the transaction from FIG. 9 is provided. The process begins at block 1000 where the network 106 receives the transaction details and associates the participating data objects 109 with a transaction object that is created in the network 106 to store information about the transaction. Next, at block 1002, the network 106 creates an event to prompt the user 102 of the mobile device 104(a) to decide if they want to share additional information with the manufacturer 701 of the purchased item.

Next, the process moves to decision block 1004 where the user 102 decides whether they want to receive products updates from the manufacturer 701 via the network 106 for the purchase. If the user 102 chooses not to accept further communication, then the process moves to block 1008 where the user 102 can defer the decision until a later time or they may decide not to receive updates at all. If at decision block 1004 the user 102 chooses to continue receiving product updates, the process moves to block 1008 where the user 102 selects the types of information for which updates are desired. These types of information may include product warranty information, product upgrade information, product recall information, or some other information related to a purchased product.

Once the user 102 has made their selection, the process moves to block 1010 where the network sets the sharing status between the user and the manufacturer based on the agreed to framework. The sharing status may be based on a set of temporary keys which are defined in the network 106 based on the context 114 of the transaction as it relates to each of the participating entities 110. The temporary keys are used to log the transaction details for a limited period of time. Once the sharing status is set, the process then moves to block 1012. There, the network 106 adjusts appropriate keys in the network so that the certain portions of the transaction become shielded from the participants.

Once the keys have been set, the process then moves to block 1014 where the network 106 stores the adjusted keys and the data associated with the adjusted keys. This process allows the network 106 to have future access to the transaction records so that they are accessible, if necessary, in the future. The process then continues to block 1016 where the network updates the data objects 109 representing each transaction participant with data related to the purchase event.

### Example—User Changes Addresses

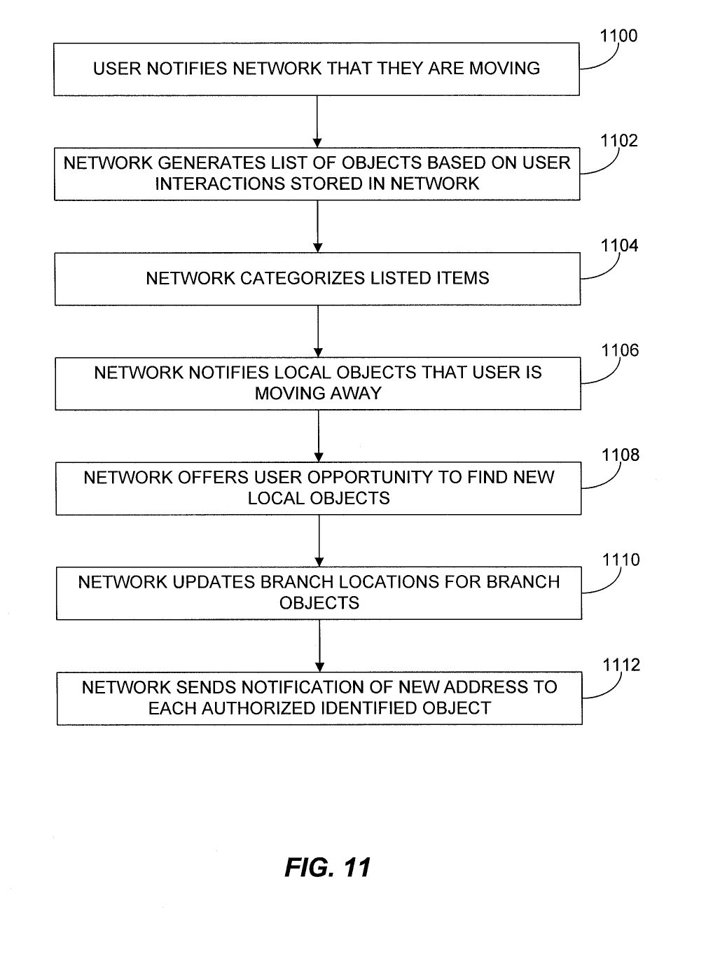

As noted previously, existing network technologies do not handle situations in which a person moves their home. In one embodiment, the network system described herein provides these services with minimal disruption and inconvenience to the user and the organizational entities associated with the user. Referring now to FIG. 11, a flowchart is provided which describes a process by which the network 106 helps a user (as represented by an identity object 112 in the network) perfect a change of address with other objects in the network 106, and similarly update those objects in view of the change of address.

The process begins at block 1100 where the user connected to the network 106 as a verified identity object 112 sends a message to the network 106 indicating that they want to move their home address to a new location. Next, at block 1102, the network 106 generates a checklist of other objects (both entities 110 and identities 112) which share address data with the identity object 112 of the user. This list may include objects representing businesses such as a bakery, a hair salon, a bank, a pizzeria, the local DMV branch, and a retail store such as “Best Buy”. In addition, the system may retrieve information from other companies that have done business with the user, and shared their address information, such as manufacturers “Sony” or “Microsoft” by way of previous transactions recorded in the network 106.

Next, the process moves to block 1104 wherein the network 106 categorizes each of the objects in the generated list according to the context of their interactions with the user object 112. For example, the bakery and hair salon may be categorized as “local” object. As a result, if the user moves far away, these objects may no longer be relevant because the user does not live near them. Other listed objects may be categorized as “branch” objects. Although the user's interaction with these objects is local (e.g., within a geographic proximity to their current address), the nature of the business represented by the “branch” object means that their may be a branch for that business in the new address location. Other objects may be categorized as “global” objects. These objects may represent those organizations which are national or global in nature, such that the user's interactions with them are not dependent on their home location. It should be noted that for each of the objects identified by the network, the user object may store an address for a business, and the business may store an address for the user. For the local and branch objects, both stored addresses may need to be updated, while for the global objects, only the address associated with the user may change.

Once the objects have been categorized, the process moves to block 1106 where the local objects are notified that the user is moving. These notifications may take the form of an automated phone call made by the network 106 or some other electronic communication sent to the object representing each of the local businesses. Next, at block 1108, the network may offer the user the opportunity to select new local objects to replace the old local objects. For example, the network may suggest a new bakery to add to the user's profile which is located near their new address. Next, at block 1110, the network 106 determines if there are branch locations for the branch objects near the user's new address. If branch locations are found in the network 106, these objects are updated accordingly to reflect their new local addresses in relation to the new address for the user.

The process then moves to block 1112 where the network 106 notifies each of the identified objects of the change in the user's address. This, of course depends on whether the user shares their home address data with any or all of the listed objects. These updates may be propagated through the use of secure messaging (in the case of a bank branch, for example), an automated phone call (in the case of a pizzeria branch, for example), an e-mail, via a defined API within the network 106, or some other communication.

In another particular embodiment, the network 106 allows a context 114 and identity to be defined for a person 102 in the health care context. The health care context 114 may allow the person 102 to authorize for specific information to be stored in the network 106 and define its accessibility to others within specific contexts 114. In this embodiment, the network 106 may include a identity-specific software service which allows the person 102 (also referred to as a user) to publish key facts about themselves in the network 106, and also allows the user 102 to control access to the information with a high degree of granularity be defining contexts 114 in which the information is made available to other subscribers within the network 106. The service may further allow the person 102 to connect to other objects 109 in the network 106 for the purpose of processing healthcare-related transaction such as insurance payments, co-pays, and the like. Although the embodiments described below involve specific health care-related embodiments, it is to be appreciated that the identity-specific software service may be used to store and manage all kinds of information specific to the person 102 in various other contexts 114.

### Example—Healthcare Context

In some embodiments, the identity-specific software service may operate within a health care context associated with the person 102. Any person 102 having an identity 112 within the network 106 may have an associated software service. The identity-specific software service may be configured to store many different types of healthcare-related information about the user 102. For example, the identity-specific software service may gather and store medical records related to the user 102 generated by doctors and other healthcare providers. The user 102 may upload these records to the network 106. Alternatively, if the doctors and/or healthcare providers exist within the network (e.g., are associated with identities 112), then the user may allow the doctors and other healthcare provides to connect with his identity-specific service to upload and store his records. Because the user 102 can determine how other network objects connect to his identity-specific service, considerable control over the data is maintained. Because of the privacy concerns associated with medical record data, the network 106 may be configured to restrict any and all access to the user's health records unless the user allows a specific connection to that information by a specific verified identity object within a specific context.

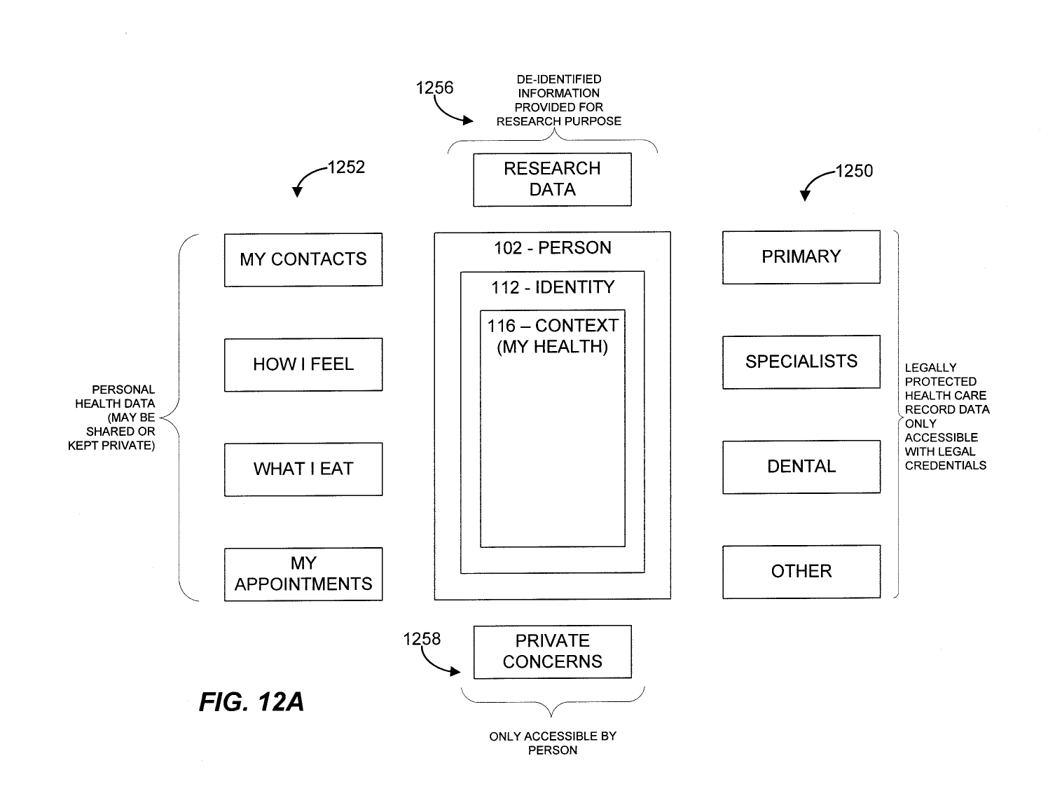

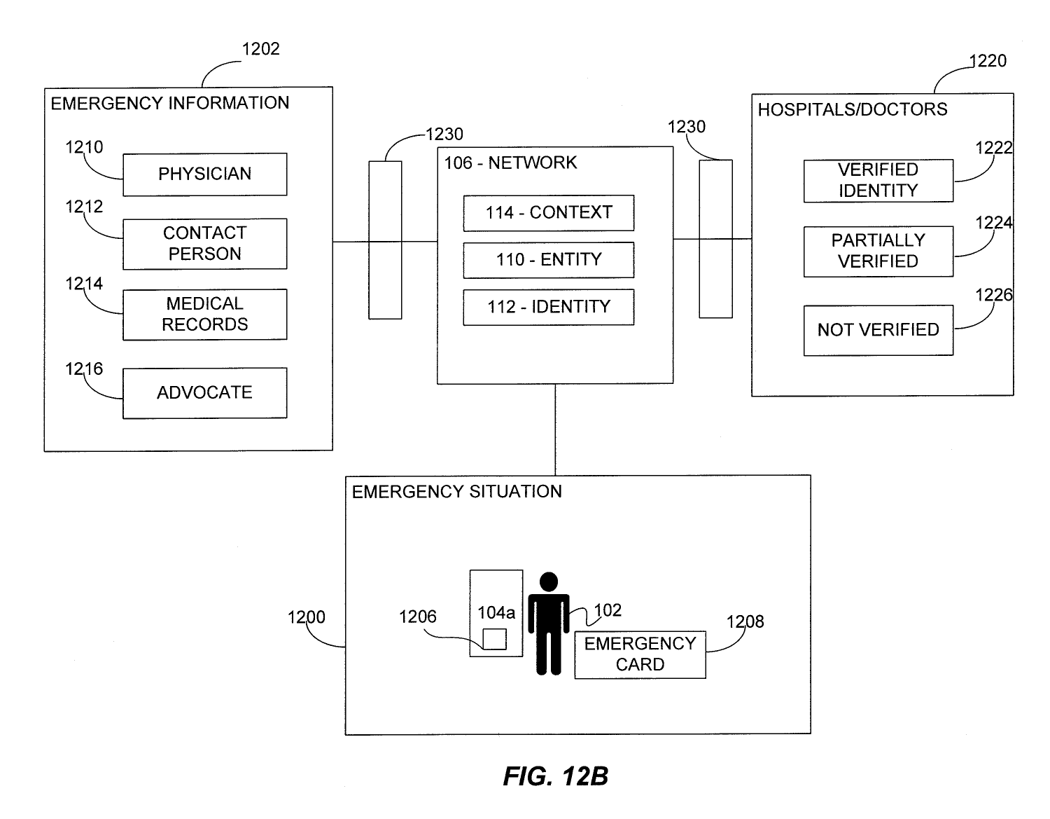

Typically this selective access is provided by creating a source object that is trusted, and which aggregates healthcare records generated by different providers and sources. FIG. 12A provides an example of how this data may be aggregated around a person 102 who exists as an identity 112 in the network 106. The aggregation of this data may form a health care context 114 associated with the identity 112 of the user 102. As shown, there are various sources of data that may be aggregated, and the different types of data aggregated from these sources may have different privacy levels associated with them. The sources of healthcare related data about the person 102 may include a health network 1250 of doctors, hospitals, insurance companies, pharmacies, and other health care entities which form a network relevant entities 110 and identities 112 related to a person 102 in the health care context 114. The data provided from these sources may be legally protected data (e.g. HIPPA data). Access to this data about the person 102 may only be provided within the network 106 to those identities verified to have the legal authorization to do so. The person 102 may also store other lifestyle-related health data 1252 in the network that is less sensitive. This data may include a schedule of doctor's appointments, medical/health goals, and other types of data that may be more broadly shared (with family members, for example) than the sensitive medical record data (which is typically shared only with doctors and hospitals). However, because this data is centered on the identity 112 of the person 102, the person 102 ultimately controls how much or little of this data may be shared with others in the network 106. Thus, in some cases lifestyle-related data maybe more sensitive, and not shared with a doctor/physician, or possible shared with one doctor having an identity in the network 106 but not other doctors, care providers, or policy holders.

In addition, some de-identified information and data 1256 may be shared with other network objects 109. (De-identified information is typically information about a person that has been stripped of data that could be used to determine their identity.) Sharing of these types of de-identified data 1256 may be useful in the context of medical research and development. The user 102 may be provided options for sharing their de-identified medical data 1256 via the network 106. As more users allows for de-identified data to be shared in the network 106, records about the person 102 on a particular topic may be aggregated and analyzed with a group, where other members remain anonymous. In addition to making it possible to aggregate data in a de-identified way with other user data, the network 106 may be configured to allow the person 102 to take a personal concern 1258 and find information about the personal concern without exposing their identity 112 within the network 106 (e.g., to advertising or exposing their personal information). The collection of all of these functions and data may be presented to the user 102 is such a ways as to provide a comprehensive view of their health. In some embodiments, this comprehensive view may be provided in a context referred to as “My Health.”

FIG. 12B is a block diagram illustrating a use case in which the network 106 may be used to provide information about the person 102 during a medical emergency situation. It is to be noted that the framework shown in FIG. 12 is similar to that shown in FIG. 7 (in the mobile shopping context). This is because the network 106 may be extended into any number of different contexts to handle real world situations accordingly. In particular, the network 106 may be configured to allow a person 102 to create an emergency notification context using their identity-specific software service in which notifications and messages may be sent to specified emergency contacts. During the course of receiving the emergency treatment, the identity-specific software service running the network 106 allows access to information about the person 102 stored in the network 106 based on permissions defined by the person.

As shown, the person 102 may encounter a medical emergency situation 1200. The medical emergency 1200 could be any type of medical emergency, such as an accident, a health event, or some other type of emergency. During a medical emergency situation, those assisting the afflicted person often make an attempt to ascertain their identity and other important information about the person 102. In these types of situations, the person 102 may be sufficiently incapacitated so that he is unable to communicate his identity and other information to those tending to his care. In order to prevent these types of situations, the network 106 may be include as part of the identity-specific software service an application configured to allows the person 102 to create an emergency card 1208 that provides access to healthcare-related information about the person that may be used in case of an emergency.

In some embodiments, a web service is provided via the network 106 by which the person 102 may input information such as personal information, emergency contacts, and medical information to create their identity 112 in the health care context 114. The information provided by the person and stored in the network 106 may then be stored and/or converted into an emergency card that is carried by the person 102 on their person. In some embodiments, the information provided by the person 102 may include emergency information 1202. The emergency information 1202 may include information that the person 102 desires to be available to those providing tending to his care during the emergency situation 1200. For example, the emergency information 1202 may include the person's primary care physician 1210. The physician may have an identity 112 within the network 106. The emergency information 1202 may also include an emergency contact person 1212. The emergency contact person 1212 may also be associated with an identity 112 within the network 106. In these instances, the emergency contact person 1212 controls how they are contacted via the network (voice, text message, email). 106. Some or all of the emergency information 1202 may be included on the emergency card 1208. Also included in the emergency information 1202 may be the complete medical records 1214 related to the person. As noted above, access to these records 1214 may be strictly guarded, even in emergency medical context. However, the person 102 may configure the identity-specific software service to permit access by verified doctors and hospitals to allow them to provide better care to the person by enabling access by either group or individual access.

In some embodiments, the emergency information 1202 may further include advocate information 1216. Advocate information 1216 typically includes information about another person who is able to legally represent the interests of the user 102. The advocate may be a lawyer having power of attorney, for example. Alternatively, the advocate may be an individual named in a living will or some other type of legal document as having authority to make healthcare decisions on behalf of the user in the event that they are unable to do so themselves. The advocate information 1216 may include information and proof (including a digital signature, a video, a witness signature, a real time uplink to the advocate, a biometric signature, an original signature) sufficient to allow for the advocate to be contacted and act accordingly (with the necessary authority) in the case of an emergency.

When the user 102 is treated for a medical emergency situation 1200, this treatment may occur at a hospital 1220 or with a doctor that does not have immediate access to the user's medical record data 1214. The network 106 may allow access to these records if the hospital 1220 exists in the network 106 and it has a verified identity 1222 in the network 106. Typically, those hospitals that are network subscribers may be fully verified and thus be allowed access to the medical records because their identity as legitimate healthcare providers has been proven within the network 106. In some situations, the hospital 1220 may not subscribe to the network 106, but may have enough contact with object in the network that a partial verification 1224 of its identity may be obtained. In these instances, more limited access to the private patient records 1214 related to the person 102 may be allowed. If the hospital does not exist as an identity 112 within the network 106, and therefore is not verified 1226, more traditional channels (such as calling the person's medical record custodian) may be used to obtain the medical records 1214.

Because much of the data about he person 102 described in FIGS. 12A and 12B may be sensitive data, those accessing the data in the course of providing healthcare services to the person 102 may be required to prove that they are entitled to the requested access. Accordingly, access to the data stored in the network 106 may be governed by requiring presentation of credentials 1230 by the party accessing the data. Different types of required credentials may include, for example, original signatures, digital signatures, encryption keys, tokens, login/password, pass codes, pass phrases, challenge questions/answers, IP addresses, visual verification, and/or biometric authentication. The required credentials may differ based on the type of data being accessed and the situation in which the data is being requested. For example, a doctor accessing calendar data related to the person 102 may be required to produce a first set of credentials 1230, while the same doctor merely reading an e-mail sent from the person 102 may be required to produce a second, more limited credential set to the network 106. Similarly, the credentials required to for access to the same data in different situations may differ. For example, the credentials required by a doctor seeking access to private health information during an emergency situation may be lessened to compensate for the urgency of the situation, while if the same doctor seeks the information in a non-emergency context, the credentials 1230 may be substantially more rigorous.

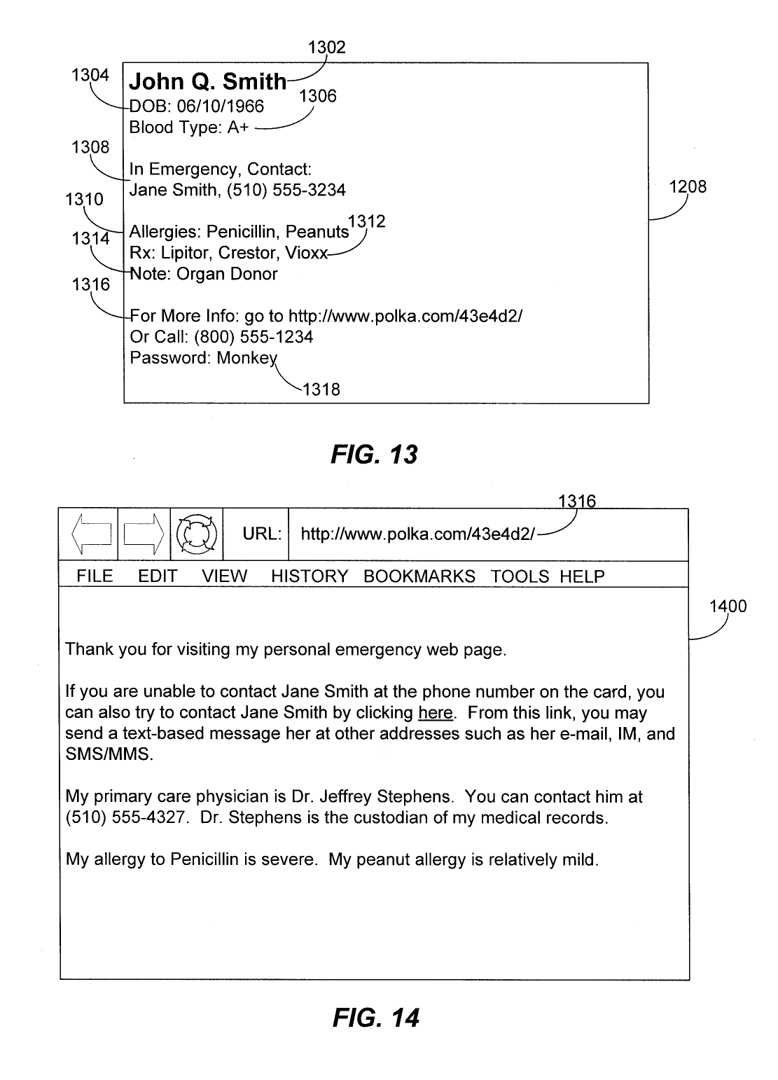

FIG. 13 is an example of an emergency card 1208 that may be created by the person 102 using the services provided by the network 106. The emergency card 1208 may be created using a web application service layer that generates a digital version of the card based on information provided by the user. The application service layer may be further configured to allow the person 102 to print a paper copy to carry in their possession. The emergency card 1208 may include various types of information starting with the person's name 1302 and date of birth 1304. The emergency card 1208 may also include the person's blood type 1306. Also provided on the emergency card may be information related to the allergies 1310 and medications 1312 of the person 102. Information regarding the organ donor status 1314, as well as advocates the person has legally designated, along with instructions for accessing copies of advocate authorizations may also be provided. Because the emergency card 1208 typically is a small wallet-sized card, it may not be suitable for providing detailed information about the person 102. Accordingly, the card may provide a web address 1316 (or some other type of location on the network 106, such as a “1-800” number as shown in FIG. 13 which delivers a voice response having information shown below in connection with FIG. 14) where additional information about the person 102 may be obtained. The web address 1316 may be indicative of the location of a personal emergency web page (discussed below in connection with FIG. 14).

Because certain private information may be made available via the page stored at the web address 1316, a pass phrase 1318 may be provided which is required to access the page. At first blush, it may seem that providing the pass phrase on the card 1208 may be a security risk. However, it should be appreciated that because the card is carried by the person in their wallet or purse, the pass phrase will only be exposed when another person has access to the contents of the wallet or purse. This type of access is common in emergency situations, but is otherwise rare. Thus, by requiring the pass phrase 1318, the information provided at the web address 1316 is generally protected, but is accessible during emergency situations 1200. The information shared even with pass phrase 1318 is limited to that which should be shared in an emergency, and does not allow access to more private medical information away. The pass phrase 1318 (which may change with each access to the site, and be correspondingly updated to the person 102 and on the card 1208) provides the mechanics to obscure the information search-engines and other techniques to find information using the web, except for those who are intended to have it. Although one particular example of an emergency card 1208 is shown in FIG. 13, it is to be appreciated that the emergency card may include less or additional information, and need not take the form of a printed out paper card.

For example, in some embodiments, the emergency card may be stored as data within a mobile device such as a cellular telephone. The mobile device may include a “MEDICAL EMERGENCY” button that allows access to the card information without needing additional login credentials. This way, a third party attempting to assist the person in an emergency situation 1200 is able obtain the information from the device, and if more detailed information is required, additional layers of appropriate credentials are utilized to provide that more detailed information.

Referring now to FIG. 14, an example of a personal emergency web page 1400 being displayed in a web browser is provided. The personal emergency web page 1400 is typically a web page stored in the network 106 that is accessed by providing the web address 1316 and pass phrase 1318 into a web browsing (or similar) software. As shown, the personal emergency web page 1400 include more detailed information about the person 102 that may be used by emergency medical personnel to provide additional information about the person 102. In this particular example, the emergency medical web page 1400 provides additional ways to contact the emergency contact 1308 specified on the emergency medical card 1208. As noted previously, the emergency contact 1308 may be associated with one or more identities 112 in the network 106. The network 106 may be configured to track the connections and/or communications the person 102 has previously engaged with the emergency contact 1308. Requests seeking information about the person 102 may also be tracked, enabling the information owner to audit of the access and use of their information. For example, if the person 102 last communicated with the emergency contact 1308 via a specific e-mail address, selecting the link on the web page 1400 may result in a message being sent to that e-mail address via the network 106 informing the emergency contact 1308 of the situation. Further, the identity 112 in the network 106 can log its communications across the network channels, and then share a portion of this data to another identity that is designated to access the shared information, in this case of emergency.

The emergency web page may also provide additional information about the physician 1210. In this particular example, the person's primary care physician, Dr. Jeffrey Stephens, is identified as being the custodian of the person's medical records. The emergency web page 1400 also provides the viewer with a contact phone number for the primary care physician. In some embodiments, the physician 1210 may also exist within the network 106. For example, an identity 112 within the network 106 may be associated with the physician 1210. In these instances, the emergency web page 1400 may be further configured to provide additional methods for contacting and/or communicating with the emergency physician 1210 based on the information stored in the network 106. This includes the ability to allow a person to contact the person or organization they represent in an emergency contact through an alias or title, for example “contact primary doctor”, rather than sharing the contact information directly. The emergency web page 1400 may also include additional medical information about the person 102. For example, the web page 1400 may provide a more detailed description of allergies, medications, and/or other preexisting health conditions. In this particular example, the person 102 reveals that the penicillin allergy is severe and the peanut allergy is not as severe.

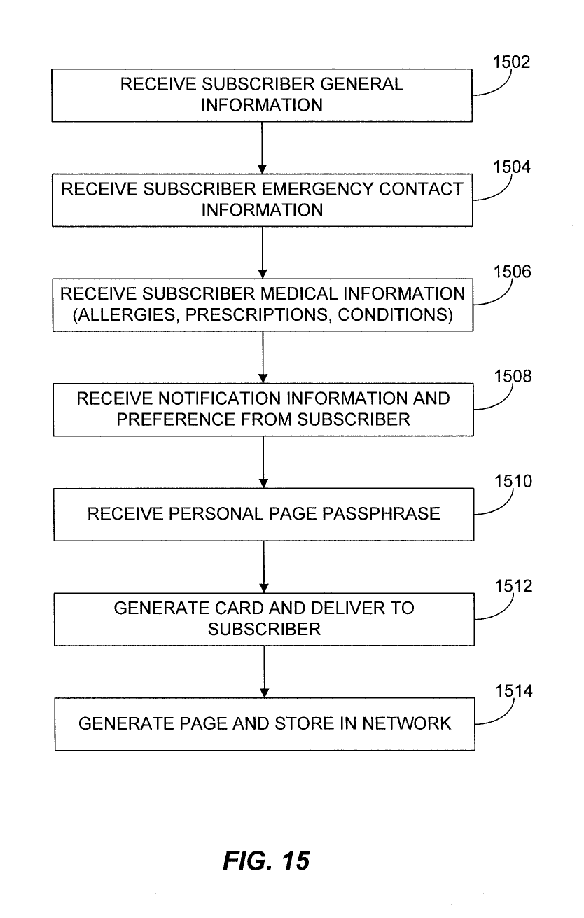

Moving to FIG. 15, a flowchart illustrates one exemplary process for generating an emergency medical card 1208 within the network 106. In some embodiments, the emergency card generation process may be carried out by a web service layer operating within the network 106. Alternatively, the emergency card generation process may be performed by software loaded onto a computing device associated with person 102 creating the emergency medical card 1208.

The process begins at block 1502, where the web service receives general information about the person 102. As noted previously, the general information may include the person's name, address, date of birth, and other general information. The process next moves to block 1504, where the web service receives subscriber emergency information 1202. Typically, this information is provided by the person creating the emergency card 1208; in some embodiments, the information may already stored in the network 106 within an identity 112 associated with the person 102. Next, the process moves to block 1506, where the web service receives medical information about the person 102. As noted above, this information may include information such as allergies, prescriptions, and medical conditions related to the person 102. At 1508, the web service may then receive notification preferences from the person 102. The notification preferences may include reminders sent to the person 102 via the network 106 to verify their information after a specific time interval. The notification preferences may also include a specification of whether the person 102 wishes to be notified when new features are added to the emergency medical card service.

Once the notification preferences have been specified by the person 102 creating the emergency card 1208, the process then moves to block 1510, where information related to the personal emergency web page 1400 is collected from the user. This information includes a pass phrase that will be used to allow access to the personal emergency web page. In some embodiments, the user may be prompted to verify the pass phrase they typed in order to ensure that the pass phrase received by the system is the one intended by the user. The personal emergency web page 1400 information may also include more detailed information about the person 102 related to their health and medical care, and different portions of this data may be aggregated across various network resources using credentialed access to gather the data from sources such as medical files, scans, images, electronic health records, and pharmacy records. Once the aggregation is enabled, the sharing with the data to subscribers is controlled and may form new groupings of access permissions. As noted previously, this information may include additional contact details for an emergency medical contact 1210, more details about a primary care physician 1212, or more details about particular health conditions of the person 102. Once the personal emergency web page information 1400 has been collected, the process may then move to block 1512, where the web service layer may generate the emergency card 1208 and deliver the card to the person 102. In some embodiments, the emergency card 1208 may be generated as a PDF file which is delivered by a web browser to the user. Alternatively, the emergency card 1208 may be a PDF file that is e-mailed to the user. In still other embodiments, different file formats such as TIF, GIF, JPG, PNG, or still others may be used. Once the emergency card has been generated, the process then continues to block 1514, where the system generates the personal emergency page 1400 for the person 102, and stores that page on the network 106. The page is stored in the network so that it may only be accessed if the pass phrase specified by the user in block 1510 is provided to the system.

In certain instances, the person 102 may travel to a place (such as a foreign country, for example) where English is not the primary language. In these instances having possession of the emergency card 1208 may be of limited benefit. In order to overcome this potential problem, in certain embodiments, a translation service may be provided by the network 106 which allows the person 102 to generate a new card in a foreign language of their choosing. The translation service may be implemented using language translation software such as Systran, LingvoSoft, Babylon, or a custom-developed translation software operating as a service in the network 106.

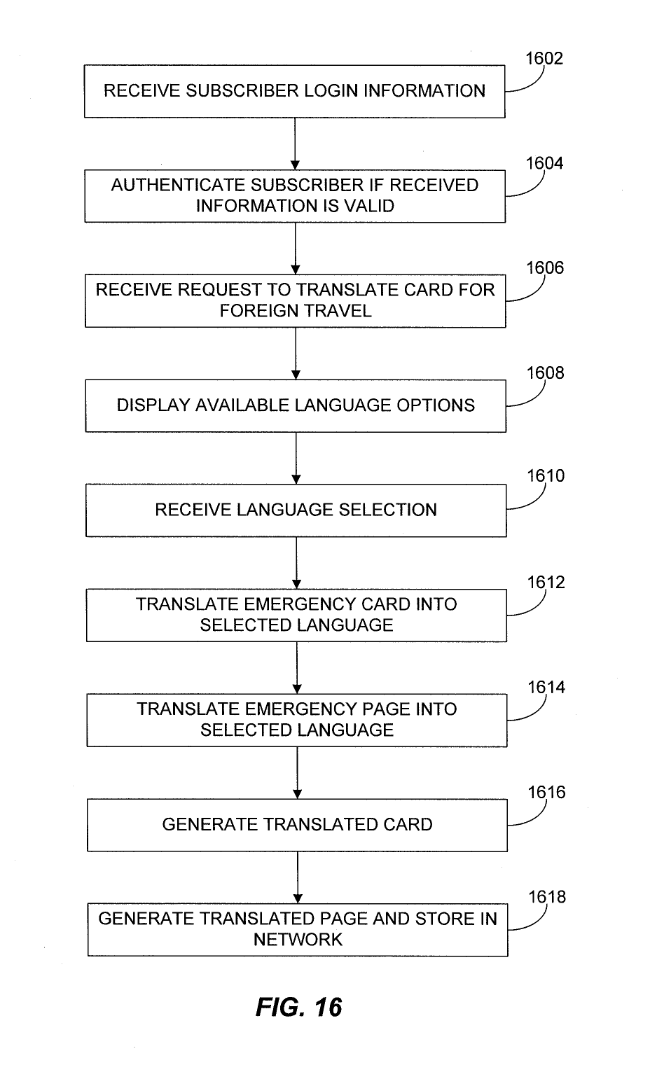

FIG. 16 is a flowchart illustrating a process by which a person may receive translation services for their emergency card 1208. The process begins at block 1602, where the person 102 submits their login information to the network 106 and the network 106 receives that login information. Next, at block 1604, the network 106 authenticates the person 102 if the login credentials received are valid. The process then moves to block 1606, where the person 102 requests card translation services for travel abroad. Typically, this request may be inputted by selecting a link on a web page associated with the user's identity 112 in the network 106. Upon receiving the request, the network 106 may then display the available language options to the user at block 1608. Next, at block 1610, the system may learn, or the person 102 may input their language selection (or selections), and the translation software is then called to translate the emergency card data stored in the network 106 into the selected language(s) at block 1614. Once the emergency card information has been translated, the network may then also translate the emergency page 1400 into the selected language at block 1614, and store the objects that comprise the page 1400 in a new location in the network. Additional rules, such as required data types, processes, and credentials for sharing and presenting information may also be also customized in the process of translation and internationalization of the content of the card to not only be readable, but also specific to the context of the local situation of the user of the card.

As part of the translation process, a new link to the emergency web page 1400 may be generated so that anyone utilizing the emergency card 1208 does not encounter a website that is not in the correct language. Once the card 1208 information and the page 1400 information have been translated, the process then moves to block 1616, where the network generates a translated card 1616 which may be printed by the person 102. Once the new card has been generated and printed, the process then moves to block 1618, where the translated page 1400 is stored in the network 106 at the location indicated on the translated emergency card 1208. In some embodiments, a network proximity service may be used to determine the nearest cache point to put the files for viewing in the likely contexts that the user will access the card using different network types in different countries and locales.

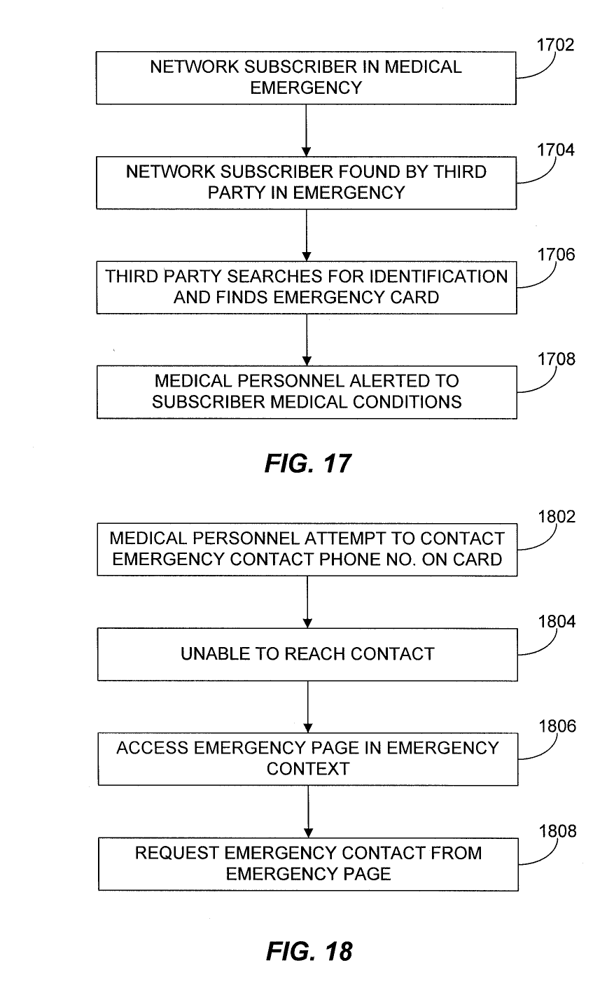

Referring now to FIG. 17, a flowchart provides an example of how the emergency medical card 1208 may be utilized when the person 102 encounters an emergency situation 1200. The process begins at block 1702 where the person 102 encounters a medical emergency situation 1200. Next, at block 1704, the person 102 is found by a third party who wishes to provide assistance to the person 102. The third party may be emergency medical personnel, or it may be a non-medical person who happened to be present. The process then moves to block 1706, where the third party searches for identification for the person 102 and finds the emergency card 1208. Typically, the person 102 carries the emergency card 1208 in their wallet or purse, so when the third party attempts to ascertain the afflicted person's identity, the emergency card 1208 may be found at that time. Once the emergency card 1208 has been found, the medical personnel attending to the person 102 are then provided with the information on the emergency card 1208. As discussed above, the information included on the card may include allergies, preexisting conditions, contacts, legal documents, and other medical information that may be relevant to the person's treatment.

Once the emergency medical card 1208 has been found during an emergency situation 1200, medical personnel treating the person 102 may use the contact information on the card 1208 to get in touch with the emergency contact person 1212 listed on the card 1208. In some cases, initial attempts to notify the emergency contact person 1212 may fail. For example, if the card provides a cellular telephone number for the contact person 1212, they may be out of range, or if a fixed line telephone number is provided on the card 1208, the person may not be present at the fixed line location. FIG. 18 is a flowchart providing an example of how this situation may be initially handled within an emergency context. The process beings at block 1802, where the medical personnel attempt to reach the emergency contact person 1212 listed on the emergency medical card 1208. At block 1804, the initial attempt to reach the contact fails, and the process then moves to block 1806 where the emergency page 1400 is accessed on behalf of the person 102 having the medical emergency situation. Once the emergency web page 1400 has been accessed the process may then move to block 1808, where additional information about the emergency contact 1212 is requested from the emergency page. Once access has been granted to the emergency web page 1400, the person accessing that page may request additional more detailed information about the person 102. If appropriate credentials are provided, the page 1400 may aggregate the person's 102 personal communication services, services on the network the person has utilized, web pages, tags, service calls to a “me server”, or microformats (such as XML, lists, RSS, XSN, hCalendar, hcard, or some other microformat known in the art) that exchange personal information 1400. A microformat is typically designed for humans first and machines second, and are a set of simple, open data formats built upon existing and widely adopted standards.

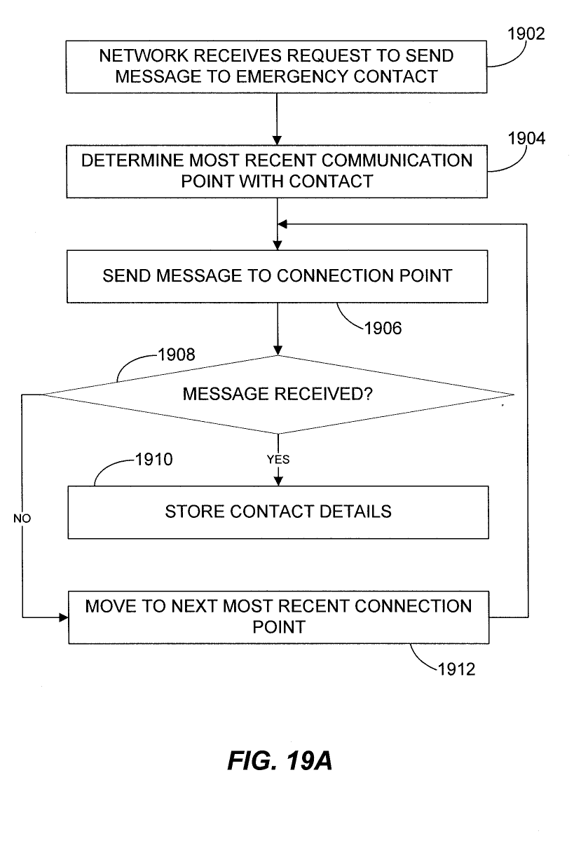

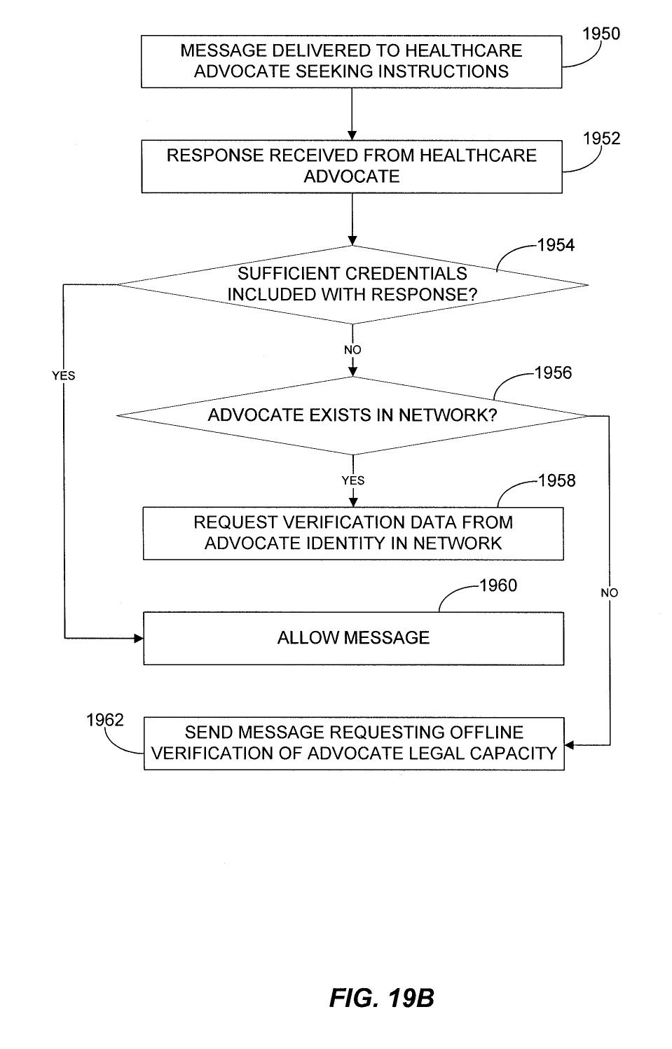

As noted above in connection with FIG. 14, the emergency page 1400 may include functionality which provides additional methods for reaching the emergency contact 1212. For example, a link on the page 1400 may cause the network service to execute computer instructions which determine whether the emergency contact 1212 exists within the network, and if so, how the emergency contact last communicated with the network. For example, the network 106 may be configured to determine the IP Address, Cell tower they last talked on, phone number dialed from, instant message sent, computer logged onto, or other way of detecting the identity of a person through a network. FIG. 19A is a flowchart which describes a process by which the network service may attempt to reach an emergency contact 1212 that exists as an entity 110 or identity 112 within the network 106. The process begins at block 1902, where the network receives a request to send a message to the emergency contact. As noted above, this request may be generated in response to a user selecting a dedicated link on the emergency web page 1400. Next, the process moves to block 1904, where the service determines how the emergency contact 1212 most recently communicated with the network 106. For example, the emergency contact person 1212 may have most recently sent a text message from their mobile device via the network 106. In this instance, the process moves to block 1906, and the network generates a message and delivers it to connection point (in this example, the mobile device of the emergency contact person) notifying them of the emergency. Once the message has been sent, the process moves to decision block 1908, where it is determined whether the message has been acknowledged by the recipient. If it is received by the recipient, the process moves to block 1910, where the details of the communication with the emergency contact 1212 are stored in the network 106. In some embodiments, this data may be added to the emergency web page 1400 so that anyone accessing the page may be aware that the emergency contact person 1212 has been reached. If at decision block 1908 the message is not acknowledged by the recipient, the process then moves to block 1912, where the network determines the next most recent connection point with the emergency contact 1212. For example, the emergency contact 1212 may have recently sent an e-mail to the person 102 via the network 106. Once the next connection point has been determined, the process returns to block 1906, and a message is sent to that connection point. This process may continue until the emergency contact person 1212 has acknowledged receipt of the message.

In some embodiments, the person 102 may authorize that certain data be exchanged among other identities 112 in the network 106 during the events of a medical emergency situation 1200. For example, for example legal documents (advocate verification) may be shared for the purpose of verifying the identity and legal capacity of the advocate 1216. In addition, payment mechanics (including provider numbers and credit card information) may be shared about the user 102 in order to expedite payment for the services. All of these data items may be provided only to those identities in the network requiring access. Referring now to FIG. 19B, an example of an advocate verification process is provided.

The process begins at block 1950 where a message is delivered over the network 106 to the advocate identified by the advocate information 1216 provided in the emergency card 1208. This message may be a communication seeking guidance on how to act with respect to the person 102 being treated for the medical emergency. Next, the process moves to block 1952, where a response is received from the advocate which provides the requested information and/or guidance. Once the response has been received, the network 106 must verify the response. Accordingly, the process moves to decision block 1954 it is determined if sufficient credentials have been provided with the response. These credentials may include a copy of a properly executed and authenticated living will designating the advocate, or some other type of verifying documentation. If sufficient credentials are included with the response, the message is allowed at block 1960, and the emergency medical treatment may proceed based on the response.

If at decision block 1954, sufficient credentials are not provided, the process then moves to block 1956 where it determines if an identity associated with the advocate 1216 exists in the network 106. If the advocate exists as an identity in the network, the process moves to block 1958 where the network 106 requests verification of the advocate's status with respect to the person 102. If, however, the advocate does not exist in the network, further verification of their authority to act on behalf of the person may be required, and a message is sent requesting offline verification of the advocate's legal capacity to act at block 1962. Thus, the network 106 allows for data to be exchanged among the identities needed access to information about the person 102 encountering the emergency situation.

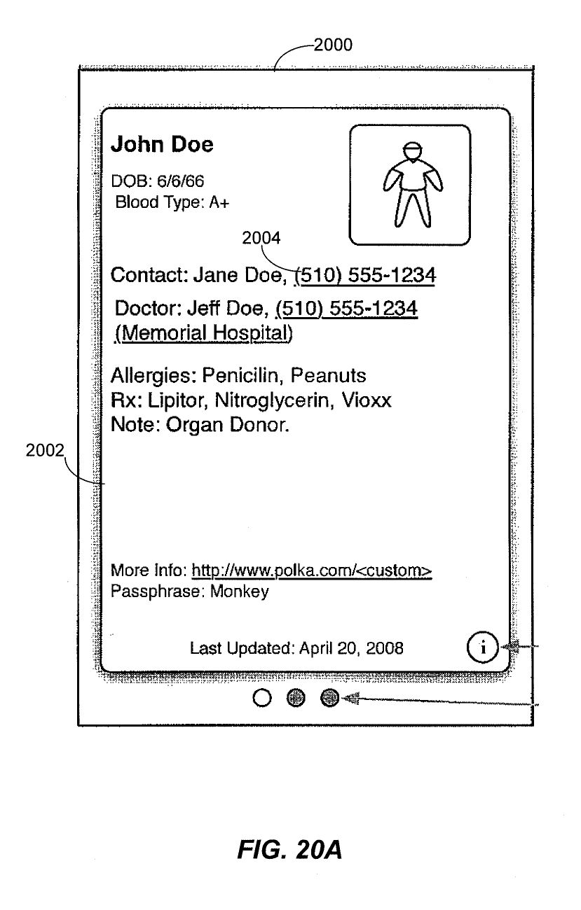

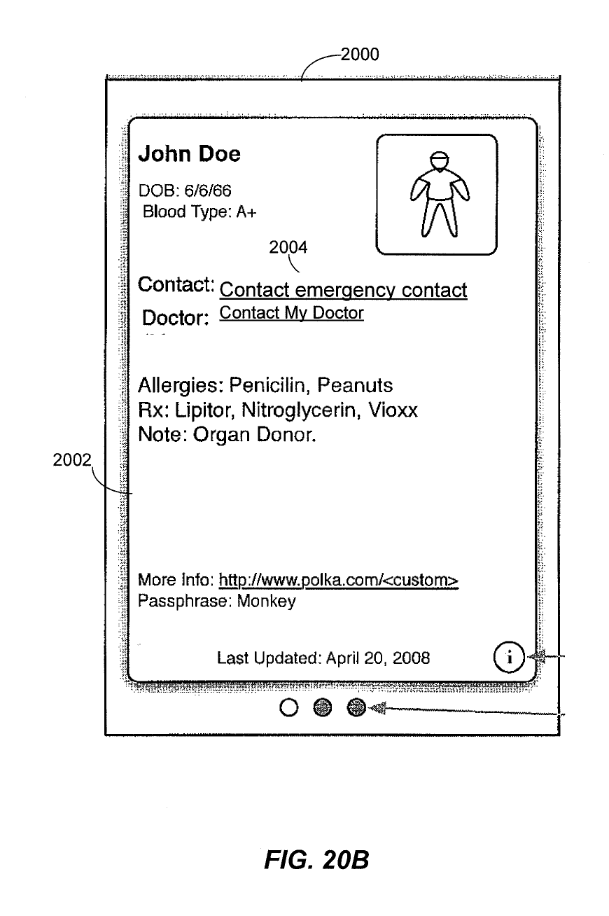

In some embodiments, the emergency medical card 1208 from FIG. 12 may be implemented as a mobile phone application which allows the person 102 to not only create their own card but manage their connections within the network 106 to others having emergency cards 1208. Moreover, the person 102 may also create emergency medical cards on behalf of their dependents or other persons. FIGS. 20-22 provide examples of a mobile phone application configured to provide emergency medical card services.

Referring now to FIG. 20A, an example of a mobile phone 2000 running an emergency medical card application 2002 is provided. As shown, the information displayed on the mobile phone 2000 is similar to the information provided on the emergency medical card described above in connection with FIG. 12. Unlike the paper-based emergency card 1208 from FIG. 12, the application 2002 may take advantage of the network functions of the phone 2000 to make the necessary connections during an emergency situation. For example, the phone number associated with the contact person 2004 may be a link which when activated by the user, directly dials the emergency contact person. The application may be delivered as a button the home screen of the telephone device. Placement of the emergency card application on the mobile device 2000 is advantageous because a person regularly carries their mobile device with them, and also because the device is already connected to the network 106, thereby allowing for communications to be sent using the device if necessary. Thus, when a person 102 encounters an emergency situation 1200, the person tending to their care may use the phone application 2002 to access the necessary information for their treatment and to contact the appropriate parties.

In the example provided in FIG. 20A, identifying information about the person 102, and the person's emergency contacts is displayed on the phone device 2000. Because displaying this information to a unverified stranger may raise privacy concerns, the application 2002 may be configured to determine that the person using the phone is not the owner of the application, and provide access to de-identified data that allows for treatment to be sought, but does not expose protected data about the person 102. FIG. 20B provides an example of how the application 2002 may de-identity information on the emergency card that is displayed on the phone device 2000. As shown, the contact information 2004 has been changed from “Jane Doe” and “Jeff Doe” respectively, to “Contact emergency contact” and “Contact My Doctor.” In some embodiments, features of the mobile device 2000 may be used to prove the identity of the person using the application. For example, the phone device 2000 may include an accelerometer which can detect signature movements. When the application 2002 is accessed, it may show only the de-identified information unless the user inputs a signature movement to prove their identity. The signature movement may be a certain sequence of movements of the physical phone device 2000 that are predetermined and stored by the application 2002. Thus, if the owner of the phone accesses the application 2002 and provides the signature movement, they are allowed to access the identifying data (and possible other more extended application functions). However, if the application 2002 is accessed by a person who does not input the signature movement, only limited de-identified data is shown.

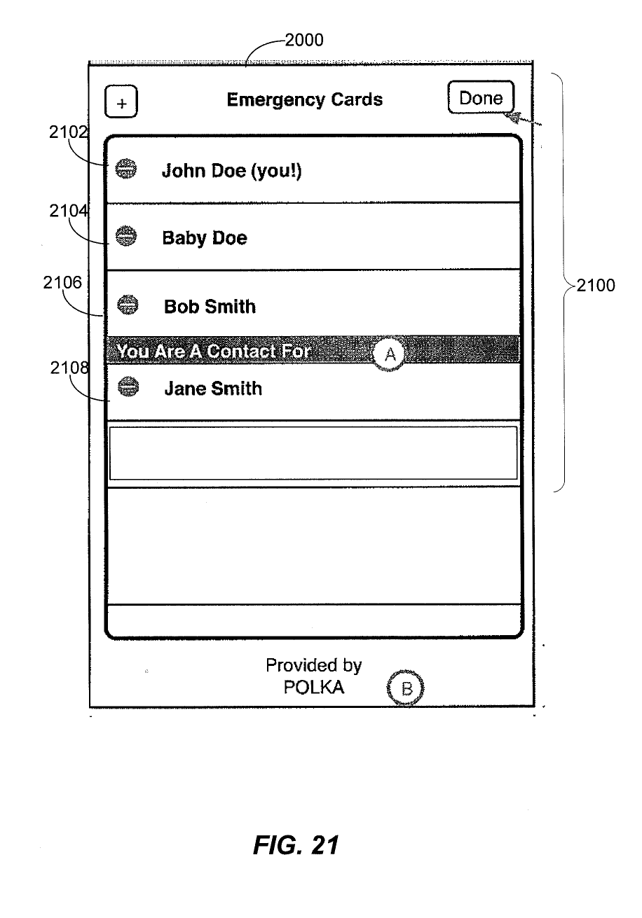

In some embodiments, the application 2002 may track emergency cards related to other objects that exist in the network 106. FIG. 21 shows an example of how these relationships may be tracked. As shown, the mobile application 2002 on the mobile device 2000 may be configured to provide an emergency card management module 2100. The emergency card management module 2100 allows the user 102 to create and management the emergency medical cards 1208 which relate to them. The emergency medical cards 1208 may include the user's primary medical card 2102. This card is the medical card associated with their identity 112 in the network 106. The person 102 may define emergency medical cards 1208 on behalf of others. For example, a card may be defined for a dependent of the user 102 such as their child (e.g., ‘Baby Doe’ card 2104), or another relative (e.g., ‘Bob Smith’ 2106). Additionally, because emergency network cards 1208 may be stored in the network 106, the network 106 may deliver to the application 2002 a list of those emergency cards 1208 within the network for which user has been designated as a contact. In the example shown in FIG. 21, the person 102 has been designated as a contact for ‘Jane Smith’ 2108. Selecting this link allows the user 102 to update their contact information so that Jane Smith's emergency card may be kept up to date.

It will be understood by those of skill in the art that numerous and various modifications can be made without departing from the spirit of the present invention. Therefore, it should be clearly understood that the forms of the invention are illustrative only and are not intended to limit the scope of the invention.

What is claimed is:

1. A computer-implemented method of delivering information across a network to assist in an emergency medical situation, the method comprising:
receiving data indicative of an emergency contact for a person, and medical information related to the person;
generating an emergency medical card based on the received data; and
delivering the generated emergency medical card to the subscriber.

2. The computer-implemented method of claim 1, further comprising:
receiving and an emergency personal page pass phrase; and
generating an emergency personal page accessible via a web address included in the emergency medical card.

3. The computer-implemented method of claim 2, wherein the emergency personal page pass phrase provides access to the emergency personal page.

4. The computer-implemented method of claim 2, wherein the emergency medical page comprises data related to secondary contact information for the emergency medical contact.

5. The computer-implemented method of claim 1, further comprising:
receiving a request for translation of the generated emergency medical card to a second language;
in response to the request, accessing translation software configured to translate data on the generated emergency medical card;
translating the data on the emergency medical card;
generating a second emergency medical card in the second language; and
delivering the translated emergency medical card to the person.

6. The computer-implemented method of claim 5, further comprising:
generating a second emergency personal page in the second language; and
protecting the second emergency personal page using a pass phrase on the second emergency medical card.

7. The computer-implemented method of claim 1, wherein the medical information related to the person comprises one or more of allergy information, medication information, and preexisting medical condition information.

8. The computer-implemented method of claim 1, wherein the generated medical emergency card is stored as an application on a mobile device.

9. The computer-implemented method of claim 8, wherein the application on the mobile device is accessible via an emergency button on the mobile device.

10. The computer-implemented method of claim 1, wherein the medical information further comprises data indicative of a primary care physician for the person.

11. A computer-implemented method of delivering a message to an emergency medical contact over a network during a medical emergency related to a person, the method comprising:
receiving a request to display a personal emergency page related to the person, the request comprising data indicative of a pass phrase;
granting access to the personal emergency page if the pass phrase is sufficient;
receiving a request to send a message to the emergency medical contact;
determining the location of a most recent communication with the emergency medical contact via the network; and
transmitting a message to the emergency medical contact at the determined location.

12. The computer-implemented method of claim 11, further comprising:
determining whether the emergency medical contact has acknowledged receipt of the transmitted message; and
if receipt of the transmitted message is not acknowledged, determining the location of a next most recent location with the emergency medical contact via the network; and
transmitting the message to the emergency medical contact that the next most recent location.

13. The computer-implemented method of claim 11, wherein if receipt of the transmitted message is acknowledged, the method further comprises:
storing information indicative of the transmitted message receipt; and
adding the information indicative of the transmitted message receipt to the personal emergency page.

14. The computer-implemented method of claim 11, wherein the location comprises at least one of an e-mail address, a text message address, and a telephone address.

15. A system for providing an identity-specific service in a network comprising:
a first module configured to receive and store information related to an identity in the network;
a second module configured to provide a user interface which allows a person associated with the identity to specify authorized connections for the stored information based on the context of the connections; and
a third module configured to receive requests to from network objects to connect to the stored information, and permit or deny access based on the specified authorized connections and the context of the requests.

16. The system of claim 15, wherein the information comprises medical record information.

17. The system of claim 16, wherein the connections to the information comprise requests by network objects to access the information.

18. The system of claim 17, where the network objects comprise verified identities in the network.

19. A mobile device configured to provide an emergency medical card service in a network, comprising:
a first module configured to receive and store information related to an identity in the network;
a second module configured to provide a user interface which allows a person associated with the identity to specify authorized connections for the stored information based on the context of the connections; and
a third module configured to receive requests to from network objects to connect to the stored information, and permit or deny access based on the specified authorized connections and the context of the requests.

20. The mobile device of claim 19, wherein the information comprises medical record information.

21. The mobile device of claim 19, wherein the connections to the information comprise requests by network objects to access the information.

22. The mobile device of claim 21, where the network objects comprise verified identities in the network.

23. A mobile device configured to provide an emergency medical card service in a network, comprising:
a first module configured to display a selection element which activates an emergency medical card application stored on the mobile device;
a second module configured to determine whether the user activating the emergency medical card application is the owner of the mobile device; and
a third module configured to selectively display information related to the emergency medical card based on the determination of the second module.

24. The mobile device of claim 23, wherein de-identified information is displayed if the user activating the emergency medical card application is not the owner of the mobile device.

25. The mobile device of claim 23, wherein the determination of whether the user activating the emergency medical card application comprises:
requesting a signature movement from the user;
detecting a movement using an accelerometer in the mobile device;
comparing the movement to a stored signature movement; and
if the detected movement matches the stored signature movement, determining that the user is the owner of the phone.

26. The mobile device of claim 23, wherein the mobile device comprises a cellular phone device.
